(19) United States
(12) Patent Application Publication
(10) Pub. No.: US 2001/0038087 A1
(43) Pub. Date: Nov. 8, 2001

(54) New chemical species of a magnecule

(75) Inventor: Ruggero Maria Santilli, Palm Harbor, FL (US)

Correspondence Address: MASON & ASSOCIATES, PA, 17757 US HWY 19 N., SUITE 500, CLEARWATER, FL, 33764, US

(73) Assignee: Hadronic Press, Inc.

(21) Appl. No.: 09/826,183

(22) Filed: Apr. 4, 2001

Related U.S. Application Data
(63) Continuation-in-part of application No. 09/586,926, filed on Jun. 5, 2000.
Application No. 09/586,926 is a continuation-in-part of application No. 09/372,278, filed on Aug. 11, 1999.
Application No. 09/372,278 is a continuation-in-part of application No. 09/133,348, filed on Aug. 13, 1998, now abandoned.
Application No. 09/133,348 is a continuation-in-part of application No. 09/106,170, filed on Jun. 29, 1998.
Application No. 09/106,170 is a continuation-in-part of application No. 08/785,797, filed on Jan. 21, 1997, now abandoned.
Application No. 08/785,797 is a continuation of application No. 08/254,377, filed on Jun. 6, 1994, now abandoned.

(51) Int. Cl. C09K 3/00

(52) U.S. Cl. 252/62.51 R

(57) ABSTRACT

A novel chemical species, called magnecules, which is composed of clusters of molecules, and/or dimers, and/or atoms formed by internal bonds due to the magnetic polarization of the orbits of at least some of the peripheral atomic electrons present in the cluster, the intrinsic magnetic field of nuclei present in the cluster, and the intrinsic magnetic fields of valence electrons present in the cluster that are not correlated in singlet couplings to other electrons to form valence bonds is disclosed.

### RELATED APPLICATIONS

The present application is a continuation-in-part application of pending U.S. patent application Ser. No. 09/586,926 filed on Jun. 5, 2000, which in turn is a continuation-in-part application of pending U.S. patent application Ser. No. 09/372,278 filed on Aug. 11, 1999, which is a continuation-in-part of pending U.S. patent application Ser. No. 09/133,348 filed on Aug. 13, 1998, which in turn is a continuation-in-part application of pending U.S. patent application Ser. No. 09/106,170 filed on Jun. 29, 1998, which in turn is continuation-in-part application of abandoned U.S. patent application Ser. No. 08/785,797 filed on Jan. 1, 1997, which is in turn a continuation application of abandoned U.S. patent application Ser. No. 08/254,377 filed on Jun. 6, 1994; the present application is a continuation-in-part of pending U.S. patent application Ser. No. 09/133,348 filed on Aug. 13, 1998, which in turn is a continuation-in-part application of pending U.S. patent application Ser. No. 09/106,170 filed on Jun. 29, 1998, which in turn is continuation-in-part application of abandoned U.S. patent application Ser. No. 08/785,797 filed on Jan. 1, 1997, which is in turn a continuation application of abandoned U.S. patent application Ser. No. 08/254,377 filed on Jun. 6, 1994; and the present application is a continuation-in-part application of pending U.S. patent application Ser. No. 09/106,170 filed on Jun. 29, 1998, which in turn is continuation-in-part application of abandoned U.S. patent application Ser. No. 08/785,797 filed on Jan. 1, 1997, which is in turn a continuation application of abandoned U.S. patent application Ser. No. 08/254,377 filed on Jun. 6, 1994.

### BACKGROUND OF THE INVENTION

1. Field of the Invention.

This invention relates, generally, to a novel chemical species, called “magnecules”, which is composed of clusters of molecules, and/or dimers, and/or atoms formed by internal bonds due to the magnetic polarization of the orbits of at least some of the peripheral atomic electrons present in the cluster, the intrinsic magnetic field of nuclei present in the cluster, and the intrinsic magnetic fields of valence electrons present in the cluster that are not correlated in singlet couplings to other electrons to form valence bonds. This new chemical species is stable under normal temperature and pressure conditions. The novel chemical species of the present invention is formed in gases, liquids, and solids, and it is useful in a variety of applications, including, but not limited to, the energy industry, the fuel industry, the paint industry, the adhesive industry and the medical and pharmaceutical industries, to name a few.

2. Description of the Related Art.

The only known prior art clusters with a well identified internal attractive bond other than that of a valence type bond consist of molecules which are bonded together by electric polarizations. These prior art clusters result from a deformation of the atomic orbits, from their conventional spherical distribution in all three directions in space, to an ellipsoidical distribution, resulting in the acquisition of one charge at one end of the ellipsoid and an opposite charge at the other end of the ellipsoid. Accordingly, this electric polarization produces clusters of molecules bonded by attractions among opposing electric polarities.

These prior art clusters are, however, intrinsically unstable. In fact, the electric polarization due to ellipsoidical deformations, in the prior art clusters, disappears under ordinary vibrational and/or rotational motion due to temperature, resulting in a spontaneous decomposition of the clusters. This lack of stability prevents any practical use of these prior art clusters formed by electric polarizations.

An additional type of prior art clusters, other than those due to valence bonds, is given by ionic clusters. However, these ionic clusters do not possess a well identified attractive internal bond, and thus have no industrial or practical value because their constituents are ionized molecules, which all have the same positive charge, thus resulting in repulsive internal forces, rather than the attractive bonds needed for the actual production of the stable clusters of the present invention.

The exposure of a gas at atmospheric pressure to an electric arc may also create magnecules. They are generated, however, in such small numbers as to be undetectable. Accordingly, these magnecules have no industrial or consumer value such as those that may be created by the arc disclosed in an unrelated invention described in U.S. Pat. No. 5,487,874 to Gibboney, Jr. Therefore, the exposure of a molecular species of gas to an electric arc leaves the original molecular species mostly unchanged in the sense that the species remains an essentially pure population of conventional molecules with only traces of magnecules. Accordingly, only when a gas is forced to pass at very high pressure through a restricted area surrounding an electric arc of a PlasmaArcFlow Reactor of the present invention can the chemical species of magnecules be produced in which a chemical species of molecules is turned into an essentially pure population of magnecules. Therefore, a well sustained pressure of about 100,000 psi is necessary, as well as other requirements discussed below, to achieve the formation of an essentially pure population of magnecules, such as that created in the PlasmaArcFlow Reactor. This sustained high pressure and other requirements, however, are not taught, disclosed or suggested by Gibboney.

In view of the prior art at the time the present invention was made, it was not obvious to those of ordinary skill in the pertinent art how a new chemical species of stable clusters could be provided with an internal attractive bond other than those due to valence or electric polarization.

### SUMMARY OF THE INVENTION

In accordance with the present invention, a substantially pure population of new, stable clusters is provided. These clusters are formed in gas, liquid, or solid compositions and are composed of clusters of two or more of a molecule, a dimer, an atom and combinations thereof in combination with one or more of another molecule, dimer or atom, and any combination thereof. Further, these clusters are detectable by peaks in mass spectrometry, which are not identifiable as any known conventional molecule. In addition, these clusters have no infrared signature when formed in gases, no ultraviolet signature when formed in liquids, and no signature for solids other than those signatures of the conventional molecules and dimers constituting the magnecules, thus establishing that the bond cannot be of the valence type.

These new clusters are called magnecules because of the magnetic nature of their internal attractive bond as described and documented in the following description. Magnecules are formed by forcing a liquid or a gas through an electric arc between at least one pair of carbon-based electrodes. A combustible gas bubbles to the surface of the liquid for collection. The heat generated during the process is absorbed by the liquid and is usable as energy via heat exchangers. Solids precipitate to the bottom of the metal vessel for collection. Under a number of conditions related to kWh, flow and geometry of the electric arc, both the gases and liquids acquire an essentially pure magnecular structure.

Some of the important novel properties of magnecules include: increased energy density; increased energy output under thermochemical reactions; increased adhesion with other substances; increased penetration within other substances; and other properties which are new when compared to the corresponding properties of the conventional molecules constituting the magnecules and any of their combinations. Consequently, the new chemical species of magnecules has new industrial and consumer applications such as fuels for internal combustion engines, fuels for fuel cells, paints, adhesives, as well as, medical and other uses.

This invention accordingly comprises the features and combination of elements in the following description, taken together with the accompanying drawings, and its scope, will be pointed out in the appended claims.

### BRIEF DESCRIPTION OF THE DRAWINGS

For a fuller understanding of the nature of the invention, reference should be made to the following detailed description, taken in connection with the accompanying drawings, in which:

FIG. 1A is a depiction of a hydrogen atom identifying prior art magnetic and electric fields;

FIG. 1B is a depiction of a hydrogen atom identifying the force fields of the new chemical species of magnecules of the present invention;

FIG. 1C is a depiction of a hydrogen atom exposed to a strong external magnetic field;

FIG. 2A is a depiction of a hydrogen molecule with a strong correlation-bond between the two valance electrons;

FIG. 2B is a depiction of a hydrogen molecule with the strong correlation bond subject to a strong external magnetic field;

FIG. 3A is a depiction of a hydrogen molecule under ordinary temperature and pressure conditions;

FIG. 3B is a depiction of the progressive elimination of the rotational degrees of freedom of a hydrogen molecule by the use of an external magnetic field or other means;

FIG. 3C is a further depiction of the final elimination of the rotational degrees of freedom of a hydrogen molecule;

FIG. 4A is a depiction of a magnecule composed of two magnetically polarized hydrogen molecules;

FIG. 4B is a depiction of a magnecule comprised of an H—H molecule and a C—H dimer;

FIG. 4C is a depiction of a magnecule comprised of an H—H molecule and a hydrogen atom H;

FIG. 5A is a depiction of an ordinary water molecule with a strong correlation-bond of the valence electrons in the two dimers H—O;

FIG. 5B is a depiction of the water molecule of FIG. 5A with ordinary rotations due to temperature and consequential recovering of the conventional spherical distribution of atomic electrons;

FIG. 6A is a depiction of the C═O molecule with a strong correlation-bond of the two pairs of valence electrons, plus toroidal distributions of the remaining electrons forming one new internal attractive bond in the interior of a conventional molecule;

FIG. 6B is a depiction of the O—C—O molecule with two strongly correlated valence bonds plus two new internal attractive bonds of magnetic origin;

FIG. 7 is a depiction of the mass spectrometric (MS) peaks of a sample gas composed by the new chemical species of magnecules, called magnegas;

FIG. 8 is a depiction of the lack of identification of one of the MS peaks of FIG. 7;

FIG. 9 is a depiction of the infrared (IR) spectrum for the entire MS scan of FIG. 7;

FIG. 10 is a depiction of the anomalous IR signature of the conventional CO₂ molecule contained in magnegas;

FIG. 11 is a depiction of the lack of identification of other IR signature of magnegas;

FIG. 12 is a depiction of the anomalous blank of the instrument following the analysis of magnegas;

FIG. 13 is a depiction of another MS scan of magnegas;

FIG. 14 is a depiction of the MS scan of magnegas obtained 30 minutes after the results shown in FIG. 12;

FIG. 15 is a depiction of the lack of identification of the MS peak of FIG. 13;

FIG. 16 is a depiction of a confirmation of the anomalous IR signature of the CO₂ molecule contained in magnegas;

FIG. 17 is a depiction of the background measurement at the end of the tests of FIGS. 13 and 14;

FIG. 18A is a photographic image of the otherwise transparent fragrance oil “ING258IN, Test 2” after magnetic polarization (10×magnification);

FIG. 18B is a photographic image of the otherwise transparent fragrance oil “ING258IN, Test 2” after magnetic polarization (100×magnification);

FIG. 19A is a photographic image of the initially transparent fragrance oil “Mixture 2” following magnetic polarization (100×magnification);

FIG. 19B is a photographic image of the initially transparent fragrance oil “Mixture 2” following magnetic polarization (100×magnification);

FIG. 20 shows the TDC scan of magnetically untreated fragrance oil “Mixture 2”;

FIG. 21 shows spectroscopic experimental evidence of magnecules in magnetically treated tap water;

FIG. 22 shows the spectroscopic experimental evidence of magnecules in magnetically treated 50-50 mixture of tap water and fragrance oil “mixture 2.”

FIG. 23 depicts the scan on LC-MS/UVD equipment conducted on the fragrance oil “ING258IN, Test 2” prior to any magnetic treatment;

FIG. 24 reproduces the scan using LC-MS/UVD equipment of the magnetically polarized oil of “ING258IN, Test 2” with 10% DPG;

FIG. 25 reproduces the scan of the dark liquid at the bottom of the sample tested in FIG. 24;

FIG. 26A depicts a PlasmaArcFlow assembly of the present invention;

FIG. 26B depicts a further embodiment of a PlasmaArcFlow assembly of the present invention;

FIG. 26C depicts yet another embodiment of a PlasmaArcFlow assembly of the present invention; and

FIG. 27 depicts an embodiment of a reactor for the operation of a PlasmaArcFlow assembly.

### DETAILED DESCRIPTION OF THE INVENTION

For purposes of the present invention, a chemical species is defined as an essentially pure population of clusters of atoms bonded together by a concrete and specific attractive force, which clusters are stable at ordinary conditions of temperature and pressure and are detectable via peaks under currently available Gas Chromatographic Mass Spectrometers (GC-MS) for gases; InfraRed Detectors (IRD) for gases; Liquid Chromatographic Mass Spectrometers (LC-MS) for liquids; UltraViolet Detectors (UVD) for liquids; and other detection methods for solids, including those based on chemical reactions.

For purposes of the present invention, molecules constitute a chemical species comprising an essentially pure population of atoms that are bonded together by attractive valence forces in their various forms, including attractive forces of co-valence, metallic valence, Π-valence, and other valence type. In fact, molecules are constituted of stable clusters of atoms under an attractive valence bond.

In the case of gases, a given molecule is identifiable by unique and unambiguous GC-MS peaks, which are distinctly different from those of any other gas molecule; this GC-MS identification can be confirmed by IRD peaks and related resonating frequencies, which are also distinctly different from those of any other gas molecule. In addition, identity confirmations are possible using other analytic methods, such as those based on average molecular weight, chemical reactions and other means.

In the case of liquids, a molecule is identifiable by unique and unambiguous peaks in the LC-MS, which peaks are distinctly different from those of any other liquid molecule and can be confirmed via unique peaks and related resonating frequencies in the UVD, which are also distinctly different than those of any other liquid molecule. Additional confirmatory tests may be performed using other analytic methods, such as those based on chemical reactions. Further, for purposes of the present invention, solids can be essentially assumed to have the same molecules as those found in liquids because obtainable from the latter via a sufficient reduction of temperature. Solid molecules, however, possess reduced intermolecular distances, as well as reduced rotational, vibrational and other motions as compared to the corresponding liquid molecules due to the reduced temperature in the solid state.

As is known in the art, the identity of a molecule can be unambiguously determined by combining two or more of the analytical methods discussed above. It is important to note that the sole use of GC-MS or LC-MS is not sufficient for a scientific determination of the identity of a molecule because a peak that is only identified by GC-MS, for example, could indeed belong to the new chemical species of the present invention and not necessarily belong to that of a molecule. This is due to the fact that the atomic constituents of the clusters of the present invention are bonded together by a force structurally different than that of a valence force, yet a magnecule may have the same atomic weight as that of a conventional molecule. In other words, in order to reach a scientific identification of molecules as well as of magnecules, and to differentiate between them, two or more of the analytical methods discussed above must be used in combination, each one verifying the results of the other.

The present invention pertains to gaseous, liquid and solid state substances. The state of the substance depends on external conditions of temperature and pressure, the underlying molecules and magnecules of a substance, however, remaining essentially the same in all three states.

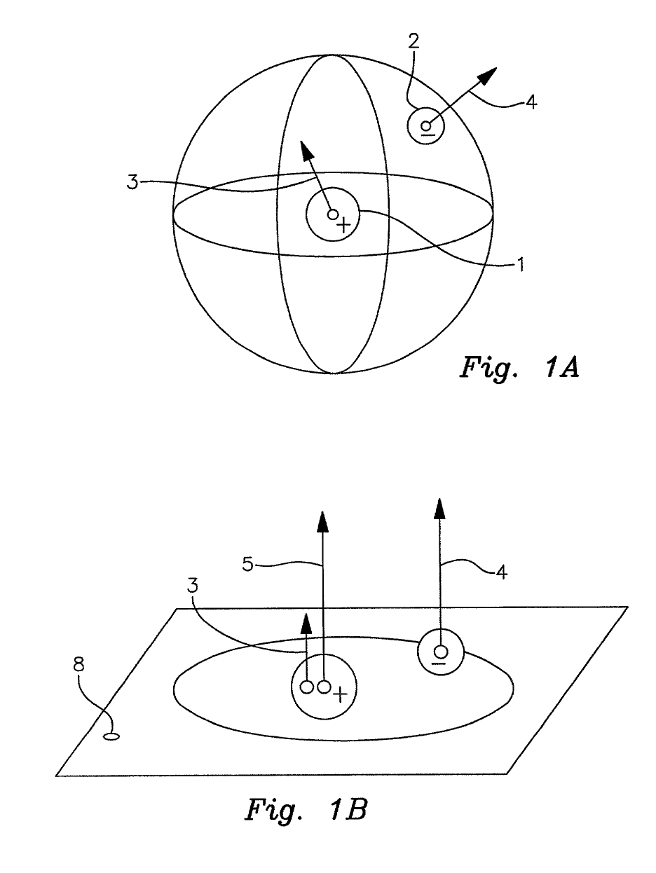

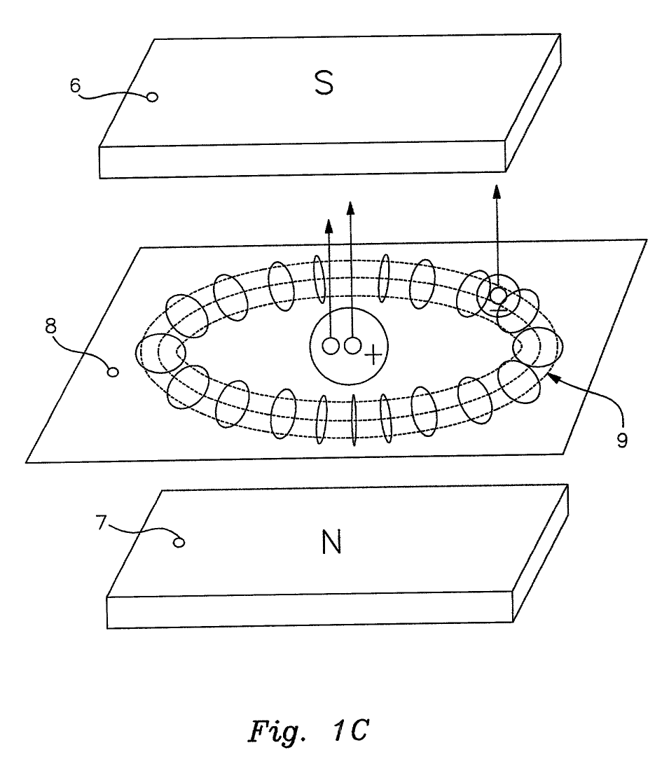

Referring now to the drawings, in which like numerals refer to like elements thereof, FIG. 1A identifies the prior art force fields of hydrogen atoms with a self-explanatory extension to all atoms. In particular, nuclei 1 have a positive charge, the peripheral electrons 2 have a negative charge, the nuclei have a magnetic moment 3, and the peripheral electrons have a magnetic moment 4.

An additional novel force which is primarily responsible for the new chemical species of the present invention is shown in FIG. 1B, which has a fifth force field, magnetic moment 5, resulting from the orbital rotation of peripheral electrons 2 in a plane 8. As shown below, magnetic moment 5 is 1,316 times greater than nuclear magnetic moments 3 thus being of the same order of magnitude of the intrinsic magnetic moments 4 of electrons.

As shown in FIG. 1C, when an atom is exposed to a sufficiently strong external magnetic field with polarities North 7 and South 6, the orbits of its peripheral electrons are no longer free to move in all directions in space, but instead must assume orbits that, at a temperature of absolute zero degrees, are contained in a plane 8. Moreover, the polarities of the magnetic field created by the orbiting electrons must be opposite to the external polarities.

If an atom is not at absolute zero degree temperature, the above-described planar polarization of the electrons orbits is impossible. Instead, the polarization yields a toroidal shape 9 of the orbits, which toroid still characterizes the new magnetic moment 5. In this case, magnetic moment 5 is decreased in value as compared to the fully planar polarization depending on the sectional area of the toroid. This loss in intensity of magnetic moment 5 of polarized electron orbits can be decreased by increasing the external magnetic field and by other means. The present invention utilizes extremely high values of the external magnetic field to provide an essentially planar magnetic polarization of the orbits of peripheral electrons so as to maximize the magnetic moment 5 of peripheral electrons.

In other words, in their natural state, all orbits are distributed in a plane, as it is evident for planetary systems. Atoms have a spherical distribution of their orbits because of their rotations due to temperature. Yet, again, in the absence of rotations, the orbit would return to their natural planar state, with the consequential emergence of the fifth force field of this invention.

An important aspect of this invention is that, unlike the electric polarizations, magnetic polarizations of coupled atoms are stable. In fact, when two or more atoms are bonded together by attractive forces due to magnetic polarizations, vibrations and other motions due to temperature occur for the magnetically bonded atoms as a single entity. Accordingly, removal of the magnetic polarizations and related bonds of the clusters of the present invention requires high-energy collisions due to high temperatures.

At its simplest, the creation of the magnetic polarization of electrons orbits of the present invention utilizes the principle of magnetization of a ferromagnetic metal by induction. Consider a ferromagnetic metal, which, initially, has no magnetic field. When this ferromagnetic metal is exposed to the magnetic field of a permanent magnet, the ferromagnetic metal acquires a permanent magnetic field that can only be destroyed at a high temperature, which temperature varies from metal to metal. The high temperature destroying the magnetic field, is called the Curie Temperature of the specific ferromagnetic metal considered. In its natural unperturbed state, the peripheral, unpaired atomic electrons of the metal have a space distribution that results in the lack of a total magnetic field. When exposed to an external magnetic field, however, the orbits of one or more external electrons are polarized into a toroidal shape with end polarities opposite to those of the external field. This phenomenon is called magnetic induction, and results in a stable chain of magnetically polarized orbits from the beginning of the metal to its end with polarities North/South-North/South-North/South- . . . This chain of polarizations is so stable that it can only be destroyed by high temperatures.

An understanding of the present invention is based on the above principle and is applicable to control the orbits of peripheral electrons for all atoms in all states, whether gaseous, liquid or solid and irrespective of whether ferromagnetic or not. A novelty of the present invention is the discovery that an orbiting atomic electron does not need to belong to a ferromagnetic metal for its orbit to be polarized by external magnetic fields. In the case of a ferromagnetic metal, however, a macroscopic global polarity is produced while, in the case of the new chemical species of the present invention, no total magnetic polarity necessarily occurs.

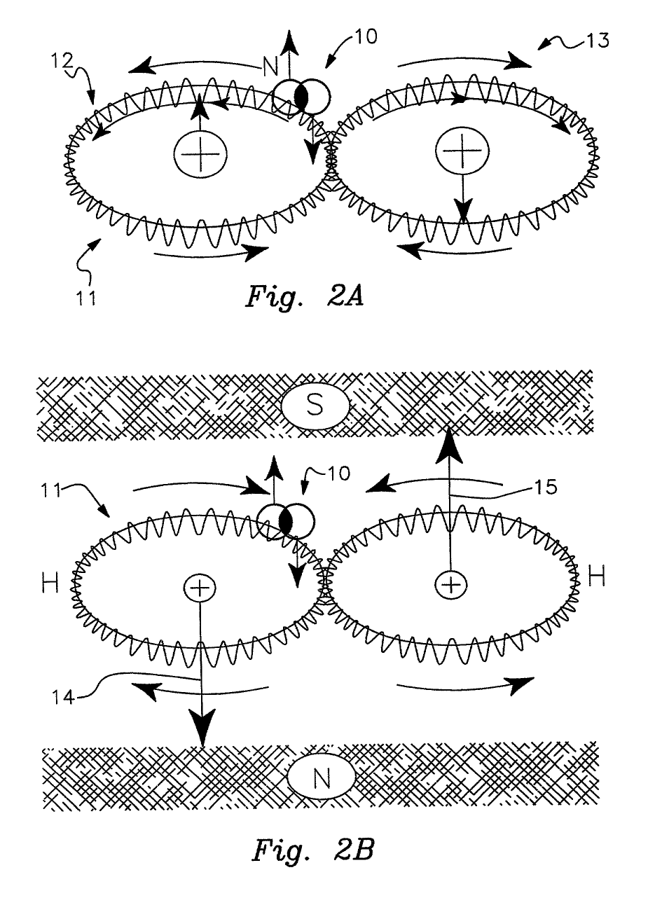

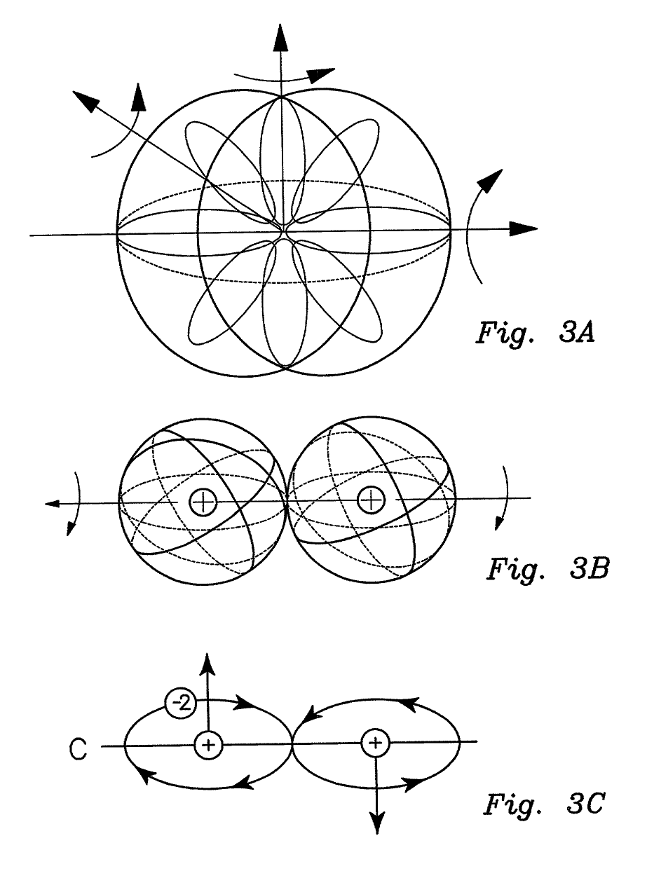

As documented in detail by R. M. Santilli and D. D. Shillady, “A new isochemical model of the hydrogen molecule”, International Journal of Hydrogen Energy, Volume 24, pages 943-956, 1999, and illustrated in FIG. 2A, the attractive force responsible for all molecules, whether ferromagnetic or not, is not due to nuclei, but rather to pairs of valence electrons, one per each atom, which must be strongly correlated-bonded in singlet couplings 10 in order to obey Pauli's exclusion principle. It then follows that the rotational directions 12, 13 of coupled valence electrons in the two atoms of the considered molecule are opposite to each other, resulting in opposite magnetic fields in the two atoms which prevent a total net magnetic polarity.

It should be indicated for clarity that valence electron pairs cannot remain permanently bonded into a singlet coupling, 10, at short distances, because they have a statistical distribution along the entire molecule. However, as it will be shown shortly, the increase of the distance between valence electron pairs has no appreciable effect on the magnetic polarizations at the foundation of this invention.

In fact, as shown in FIG. 2B, when a non-ferromagnetic molecule, such as that of the hydrogen, is exposed to external magnetic fields, the orbits of the coupled valence electrons can indeed be polarized in individual atoms, but, again, the polarities in the two atoms are opposite to each other, resulting, again, in the lack of a total net magnetic polarity which constitutes the very explanation of the non-ferromagnetic character of the molecule considered.

Since the new magnetic bond of this invention occurs at the level of individual atoms, the creation of the new chemical species of magnecules does not necessarily require a total net magnetic polarity. Thus, the new chemical species also exists for all substances, whether ferromagnetic or not.

The numerical value in rationalized units of the magnetic moment M created by a rotating charge q is as shown in equation (1),

M=(qLm)/2n (1)

where L represents the angular momentum and m is the unit of magnetic moments. By plotting known numerical values, the ratio between the magnetic moment of an orbital electron, M(orbital), in the hydrogen atom and the intrinsic magnetic moment of the nucleus, M(proton), in the hydrogen atom, which is M(proton)=1.4107 m, can be calculated as shown in equation (2),

M(orbital)/M(proton)=1,856.9590/1.4107=1,316.3387. (2)

With reference to FIG. 1C, note that the total magnetic moment, M(tot), for a hydrogen atom under a strong external magnetic field is the sum of all three magnetic moments: M(proton) 3, M(electron) 4, and M(orbital) 5. Accordingly, an isolated hydrogen atom at ordinary temperature and atmospheric pressure, when exposed to a magnetic field of ten Tesla, acquires a total magnetic field as shown in equation (3),

M(tot)=M(proton)+M(electron)+M(orbital)=3,500 m. (3)

The above value is about 20% less than the total value at absolute zero and yet is about 2,500 times larger than the nuclear magnetic moment.

When the hydrogen atom is part of a hydrogen molecule, the above numerical value is smaller because the two electrons are now coupled into a valence bond. In this case, as illustrated in FIGS. 2A and 2B, Pauli's exclusion principle requires that the two electrons are bonded-correlated in a singlet coupling 10 with antiparallel spins and magnetic moments. In turn, such a singlet coupling results in the total intrinsic magnetic moment of the paired electrons being essentially null. An important consequence of this property is that, for an isolated hydrogen atom the intrinsic magnetic moment of an electron can indeed contribute to the total magnetic polarization and related bond. In the case of a hydrogen molecule, however, the total intrinsic magnetic moment of the two electrons is essentially ignorable as a necessary condition to verify Pauli's exclusion principle. Accordingly, in the hydrogen molecule, only the orbit and intrinsic magnetic moments can contribute to a new bond.

Note that the above argument essentially remains unchanged when the valence pairs are not bonded into the singlet coupling 10 because they must remain with antiparallel spin and magnetic moment in order to obey Pauli's exclusion principle, thus resulting again in an essentially null total intrinsic magnetic moment when computed on a molecular basis.

As shown in FIG. 2A, the orbit magnetic moment of a coupled pair of valence electrons is numerically the same as that of one individual electron because the charge in the numerator of equation (1) is double the charge of a single electron, while the mass in the denominator is also double. Accordingly, the two equal factors in the numerator and denominator cancel each other, thus yielding again the numerical value as shown in equation (2), that is, 1,316.3387. The numerical value derived from equation (3) is however, considerably reduced. Specifically, one atom of a hydrogen molecule at ordinary temperature and pressure, when exposed to a magnetic field of about ten Tesla, acquires a total magnetic field shown in equation (4),

M(total of hydrogen in molecule)=M(protonl)+M(orbital)=1,500 m (4)

which value is approximately 19% less than the ideal total value of 1,858.3697 in the absence of vibrational and other motions, and only 42% of the value of equation (3).

It is important to note that the total polarized magnetic field of an individual hydrogen atom is almost two times greater than the total polarized magnetic field of the same atom when it is part of a molecule. This difference demonstrates that the new chemical species of the present invention, which is based on magnetic bonds, can indeed admit isolated atoms and does not necessarily require molecules.

Similarly, it is important to note that in the present invention there is a large dominance of the orbit magnetic moment over the intrinsic nuclear field for any possible magnetic bond. In fact, the intrinsic nuclear field is approximately 1,316 times smaller than the orbit magnetic moment. In addition, on an atomic scale, nuclei are at large distances from the peripheral electrons. Accordingly, whether for a valence bond or a magnetic bond, peripheral electrons play a central role in any cluster.

The magnetic polarization of atoms larger than hydrogen is easily derived from the calculations discussed above. Consider, for example, the magnetic polarization of an isolated atom of oxygen. For simplicity, assume that an external magnetic field of ten Tesla polarizes only the two peripheral valence electrons of the oxygen atom. Accordingly, its total polarized magnetic field is of the order of twice the value of equation (3), i.e., of the order of seven thousand rationalized units of magnetic moments. However, when the same oxygen atom is bonded into the water or other molecules, the maximal polarized magnetic moment is twice the value of equation (4), namely about half of the preceding value.

Ionizations do not affect the existence of magnetic polarizations, and they may at best affect their intensity. In fact, an ionized hydrogen atom is a naked proton, which acquires a polarization of the direction of its magnetic dipole moment when exposed to an external magnetic field. Therefore, a ionized hydrogen atom can indeed bond magnetically to others. Similarly, when oxygen is ionized by the removal of one of its peripheral electrons, its remaining electrons are unchanged. Consequently, when exposed to a strong magnetic field, such an ionized oxygen atom acquires a magnetic polarization that is identical to an unpolarized oxygen atom, except that it lacks the orbit magnetic moment of the missing electron. Ionized molecules or dimers behave along similar lines. Accordingly, the issue as to whether individual atoms, dimers or molecules are ionized or not will not be addressed from hereon because it is not necessary for the scope of this invention.

As illustrated in FIG. 2A, for purposes of the present invention, the orbit of the two coupled-correlated valance electrons in the hydrogen molecule is expected to have shape 11 of two joined ellipsoids (noted herein as “oo”), with each o-branch orbiting around each nucleus. This type of oo-shaped orbit is essentially similar to the stable orbit of a planet in certain binary stars. As a result, the two directional rotations, 12 and 13, of the coupled-correlated valence electrons in the two o-branches are opposite to each other. This assumption of opposite directions of rotations of the coupled-correlated valence electrons in the transition from one orbit to the other is necessary to prevent all molecules from acquiring the same magnetic polarization when exposed to an external magnetic field, with consequential ferromagnetic character, which would be in dramatic disagreement with experimental evidence, since only those substances having unpaired electrons can be ferromagnetic.

It then follows that, with respect to FIG. 2B, the two magnetic polarizations, 14 and 15, of the two atoms of hydrogen molecules exposed to a strong external magnetic field are opposite to each other, thus confirming the diamagnetic character of the hydrogen molecule.

It is important to note that the magnetic polarization at the foundation of the present invention is a physical notion, which is best expressed and understood by physical orbits. Nevertheless, the magnetic polarization of the orbits of peripheral atomic electrons can also be derived by orbitals of conventional use in chemistry. For example, consider the description of an isolated atom via the conventional Schroedinger equation (5)

H|>=E|>, (5)

where H=K+V is the usual Hamiltonian representing the sum of the kinetic energy K and the potential energy V, E is the eigenvalue of H, and |> represents a state on the Hilbert space with Hermitean conjugate <|. Orbitals are expressed in terms of the probability density |<| |>|. The probability density of the electron of a hydrogen atom has a spherical distribution. Specifically, the electron of an isolated hydrogen atom can be found at a given distance from the nucleus with the same probability in any direction in space.

Let us return now to FIG. 1C in which a hydrogen atom is exposed to a strong external magnetic moment M. This case requires the new Schroedinger equation (6),

(H+M)|>′=E′|>′. (6)

From the above equation, it is readily discernible that the new probability density of the electron, |<|′ |>′|, can not be the same in all directions in space, but must assume a toroidal polarization 9 shown in FIG. 1C, which is exactly that predicted by physical orbits.

As is known in the art, atoms in their natural state do not possess a magnetic polarization of the orbit of peripheral electrons. Accordingly, such a polarization is not inherent in nature and must be intentionally fabricated. The present invention creates the above described magnetic polarizations in the structure of individual molecules, dimers and atoms irrespective of whether they are ionized or not and ferromagnetic or not. Further, the present invention utilizes such induced magnetic polarizations for the industrial production of a new chemical species given by an essentially pure population of clusters composed of individual molecules, and/or dimers, and/or atoms under a new bond of magnetic polarization origin. These novel clusters are stable at ordinary conditions of ambient temperature and atmospheric pressure. The present invention also describes the equipment and methods suitable for producing and analyzing these clusters, which are not molecules because their bond is not a valence bond. Since the new bond creating these clusters is of a magnetic type, the new clusters are called magnecules, which terminology is very useful to distinguish magnecules from conventional molecules.

As is known in the art, molecules are uniquely and unambiguously identifiable by two complementary measurements. The first identification is done by GC-MS for gases, LC-MS for liquids, and other conventional measurements for solids, resulting in characteristic peaks which are identified by the computer as being identical to a peak on scientific record of a known molecule. The second complementary identification is done by IRD for gases and UVD for liquids that identify peaks and related resonating frequency characteristics of the molecule considered, which peaks are equally identifiable by computer analysis as coinciding with the IR peak and resonating frequency on scientific record of a known molecule.

Atoms, as is known in the art, do not have an IR or UV signature. Further, dimers often have an IR or UV signature that coincides with the IR or UV signature of the related molecule. For example, LC-MS analysis does indeed detect a complete liquid molecule, such as that of water, H₂O, while UVD analysis does not identify the water molecule per se, but only its dimer H—O.

The identification of the new chemical species of magnecules of the present invention, requires the following three steps: 1) Magnecules must be detected as clearly identified peaks in GC-MS scans for gases, LC-MS scans for liquids, and other conventional means for solids. The peaks of the magnecules produced by GC-MS scans for gases and LC-MS scans for liquids remain unidentified following a computer search and comparison with all known molecules; 2) The magnecules individual peaks which are not identifiable by the MS scan also have no IR signature for gases and no UV signature for liquids, other than the signature of its molecular or dimer constituents; and 3) The identification of the magnecules is completed and verified by additional experimental evidence, such as measurements of the average density of magnecules which must be greater than that of any molecule contained in the magnecule, as well, as any of their combinations. Finally, the identification is completed by proof that the internal bond is not of valence but of magnetic polarization type as permitted by a number of unique characteristics solely possible under magnetic polarities as described below.

It must be stressed that, for gases or liquids under conventional conditions and not exposed to a magnetic or other field, MS scans are generally sufficient for the identification of molecules. Accordingly, the great majority of GC-MS and LC-MG have no IRD or UVD, respectively, and GC-MS equipped with IRD or LC-MS equipped with UVD are instruments generally available in military, governmental or other specialized laboratories. However, when gases or liquids are exposed to strong magnetic fields or other interactions identified below, the sole use of MS detectors is grossly insufficient to identify molecules because the identifications by a MS scan must be completed with IR or UV detections. The latter identification is necessary because a peak with a given large atomic weight may appear as being that of a given molecule under the MS scan, while in reality it may have no IR or UV signature at all, thus establishing that said large peak cannot possibly be a molecule, since only the hydrogen and very few other light molecules have the perfect spheridicity necessary for the absence of an IR signature, while it is physically impossible for large molecules to reach such a perfect spherical symmetry. As a result, scientific measurements which must be used to identify magnecules are given by GC-MS equipped with IRD, or LC-MS equipped with UVD, where the word equipped is specifically referred to the requirement that both the MS and the IR or UV scans refer to exactly the same range of atomic weight in standard a.m.u. units. In fact, only under the latter condition can a given cluster be jointly analyzed under an MS and an IR or UV scans.

The following terminology applies for purposes of the present invention:

a. The word atom is used in its conventional meaning as denoting a stable atomic structure, such as oxygen, irrespective of whether the atom is ionized or not and ferromagnetic or not.

b. The word dimer is used to denote part of a molecule, irrespective of whether the dimer is ionized or not, and composed of at least two atoms, such as O—H, C—H, etc., where the symbol “—” denotes a valence bond.

c. The word molecule is used in its internationally known meaning of denoting a stable cluster of atoms bonded by the coupling of the pairs of all available valence electrons, such as H₂, H₂O, C₂H₂, etc., irrespective of whether the molecule is ionized or not, and ferromagnetic or not. Molecules are uniquely and unambiguously identifiable by GC-MS equipped with IRD at the gaseous state, and by LC-MS equipped with UVD at the liquid state.

d. The word magnecule is used to represent clusters of two or more of a molecule, a dimer, an atom and combinations thereof in combination with one or more of another molecule, dimer or atom, and any combination thereof formed by an internal attractive bond among opposing, generally toroidal polarities of magnetic polarized orbits of at least one peripheral electron of the atoms constituting said magnecules in conjunction with a polarization of intrinsic magnetic moments of the nuclei of said atoms and a polarization of intrinsic magnetic moments of electrons when not correlated into valence bonds with antiparallel spins. Magnecules are stable under normal temperatures and pressures and are identifiable by GC-MS equipped with IRD for the gaseous state or LC-MG equipped with UVD for the liquid state or other means for solids via procedures established below. Said generally toroidal polarization needed for the production of magnecules can be caused by external magnetic, or electromagnetic fields or by other means, including but not limited to microwaves, friction, pressure, etc. Due to the magnetic bond, magnecules, have a variable atomic weight. depending upon the number of molecules, and/or dimers, and/or atoms involved in the toroidal polarization. Magnecules are identifiable in mass spectrometry by novel peaks, which are unidentifiable by a computer search among all known conventional molecules. Also, magnecules have no infrared signature for gases, no ultraviolet signature for liquids and no other signature for solids except the infrared or ultraviolet signature of the individual molecules or dimers constituting said magnecules, for example, H₂, C—O, H—O, etc. Magnecules have unique physical and chemical characteristics, including, but not limited to, a unique energy content, a unique density, a unique adhesion to and penetration within other substances, and a unique viscosity, to name a few. All magnecules, including their mass spectrometry peaks and unique physical and chemical characteristics, disappear at a sufficiently high temperature, such as at the temperature of combustion. A magnecule is considered elementary when composed of only two molecules. A magneplex is entirely composed of several identical molecules. Magneclusters are composed of molecules of different types.

e. The words chemical species are used to denote an essentially pure population of stable clusters, thus implying the conventional chemical species of a molecule and the new chemical species of magnecules.

The new chemical species of the present invention comprising of an essentially pure population of magnecules, can be industrially created in a form admitting of practical uses for any given substance in the gaseous or liquid state. Magnecules at the solid state are created by the solidification of liquid magnecules due to a reduction in temperature. As an illustrative example, consider the simplest possible gaseous chemical species, that composed of a conventional hydrogen molecule H₂=H—H.

Turning now to FIG. 3A, the hydrogen molecule is a perfect sphere due to the rotation of the two hydrogen atoms in all space directions, for which reason the hydrogen molecule has no IR signature. The present invention deals with progressive means for the elimination of the rotational degrees of freedom depicted in FIGS. 3B and 3C to create the desired magnetic polarization. The first step is that of eliminating the rotation of the two hydrogen atoms around their center of gravity as depicted in FIG. 3B, while each hydrogen atom remains with its internal rotation, resulting in the known spherical distribution of the electron orbits or orbitals in each hydrogen atom. The next and final step is the elimination of the latter rotations within the individual atoms, all the way to the polarization of the orbit of the coupled valence electrons which, at a temperature of absolute zero degrees, can be assumed to be, as depicted in FIG. 3C, within a plane or within a toroid depending on the intensity of the external magnetic field per a given temperature.

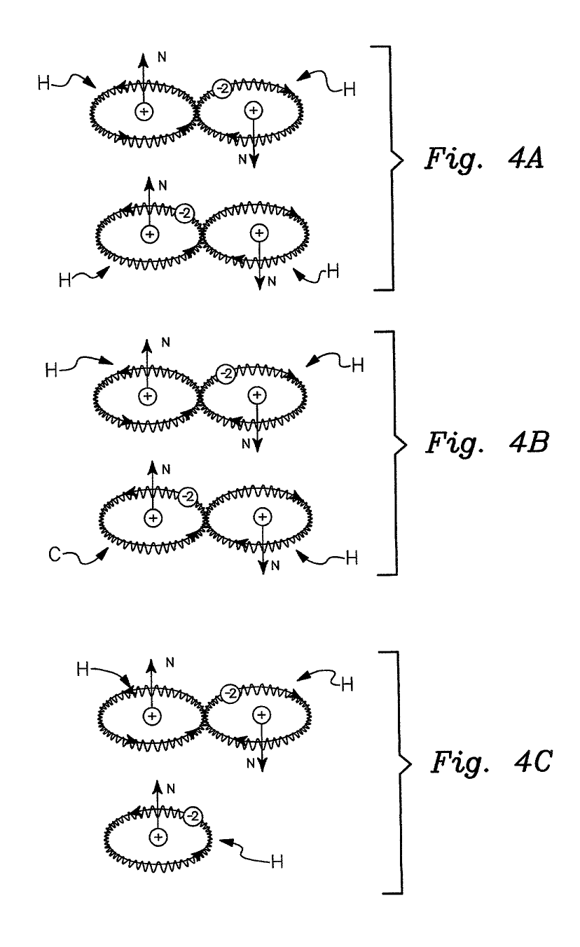

With reference to FIG. 4A, once two hydrogen molecules reach the polarization shown in FIG. 3C, they can bond together by the attractive force between opposing polarities of the magnetically polarized fields of their orbiting electrons, as well as of their nuclei, although in this case not for electrons since their coupled magnetic polarities are opposite to each other, by establishing in this way a bond chain, such as North-South/South-North/etc. The resulting cluster composed of two molecules is denoted by (H—H)x(H—H)=H₂xH₂, where “x” denotes herein a magnetic bond. The latter structure is called an elementary hydrogen magnecule. Such magnecule is manifestly stable since any possible rotation due to temperature can only occur for the state H₂xH₂ as a whole, while any separation of said magnecule into individual H₂ molecules requires a collision having an energy greater than the magnetic binding energy. This elementary hydrogen magnecule is composed of magnetic bonds having opposite polarities, thus resulting in a lack of a total net magnetic polarity. In other words, magnecules, which are constructed from given molecules, preserve the diamagnetic or ferromagnetic character of the molecular constituents.

FIG. 4A also illustrates why magnecules do not have an IR signature other than that of their constituents, referred to as the vibrational frequency range of currently available IRD. This is due to the fact that the inter-atomic distance in the magnetic bond is on the order of 10¹² cm, while the inter-atomic distance of conventional valence bonds is on the order of 10⁻⁸ cm. As a result, the vibrational frequency of a magnetic bond of the present invention is not available in any of the current IRD equipment because it is at least 10⁴ greater than the largest resonating frequency currently measurable.

As illustrated in FIG. 4B, a magnecule can also occur between a molecule H—H and a dimer C—H, irrespective of whether the latter is ionized or not and/or ferromagnetic or not. Finally, as depicted in FIG. 4C, a magnecule can also occur between a hydrogen molecule H—H and an isolated hydrogen atom H. In fact, as computed and illustrated earlier, the strength of the magnetic bond of an isolated hydrogen atom to a hydrogen molecule is almost twice the strength of the magnetic bond between two hydrogen molecules. As indicated earlier, this follows from Pauli's exclusion principle, i.e., the condition that the two electrons of the hydrogen molecules must be coupled in singlet, namely, with antiparallel spins and magnetic moments, thus resulting in an essentially null total magnetic moment for the paired electrons with a consequential lack of appreciable contribution for magnetic bonds. The valence electron of an isolated hydrogen atom, on the contrary, is not coupled, and therefore, it is free to contribute to a magnetic bond via its intrinsic magnetic moment. Note that the magnecule (H—H)xH shown in FIG. 4C can not be a molecule because, once the two electrons of the two hydrogen atoms bond-correlate themselves into a singlet quasi-particle state to form the molecule H—H as in FIG. 2A, they cannot bond with a third electron for various reasons, e.g., because a coupled electron pair is a Boson with spin zero while an individual electron is a Fermion with spin ½.

A gas magnecule can be formed by a combination of the magnecules of FIGS. 4A, 4B and 4C with several other molecules and/or dimers, and/or atoms resulting in large clusters which have been detected to have an atomic weight all the way to 1,000 a.m.u. for gases, and tens of thousands a.m.u. for liquids. Further, depending on the geometry of the cluster, when a hydrogen atom in the core of a magnecule is entirely surrounded by molecules, the hydrogen atom will remain an isolated atom. This also holds true for any other isolated atom or dimer.

As reviewed below, the presence of individual unbonded atoms within magnecules has been experimentally verified and permits important industrial and consumer applications, such as, the production and use of gaseous compositions called magnegas composed of an essentially pure population of magnecules produced as a by-product in the recycling of liquid waste via a submerged electric arc. Magnegas has a unique energy content because, during combustion, it releases about three times the energy expected from the combustion of the conventional molecules constituting magnegas and of any of their combinations. This unique energy release is due to the fact that combustion breaks the magnecules, thus releasing isolated atoms and dimers which, at that moment, recombine to form ordinary molecules with a consequential release of a large quantity of energy that is non-existent in fuels having conventional molecular structures.

As a specific example, the atomic composition of magnegas produced via electric arcs submerged within distilled water with one electrode composed by a consumable pure graphite is made of 50% hydrogen atoms, 25% oxygen atoms and 25% carbon atoms, plus other atoms as impurities in parts per millions. In a conventional molecular composition, said H, O and C atoms would combine into conventional molecules. Since the affinity between carbon and oxygen is much greater than that between oxygen and hydrogen, the first molecular formation is that of CO, the second being that of H₂, with traces of O₂, H₂O and CO₂. Therefore, the conventional chemical composition of a gas produced by an electric arc submerged within distilled water with one consumable graphite electrode is essentially given by 50% H₂ and 50% CO plus low levels of H₂O, CO₂ and O₂. Note that no light or heavy hydrocarbon can be admitted since the local temperature of a submerged electric arc is on the order of 10,000° C., at which temperature no hydrocarbon can possibly survive, assuming that it can be formed.

It is well known that the energy content of said 50-50 combination of conventional molecules H₂ and CO is 315 BTU/cf. By comparison, various measurements have established that the energy content of magnegas with the same atomic constituents is about 950 BTU/cf, namely, about three times the predicted value. The excess energy content of magnegas produced from water and carbon electrodes has been proven beyond doubt by the inventor by converting a 1998 Honda Civic originally produced to run on compressed natural gas with its well known energy content of 1,050 BTU/cf. The compressed natural gas was removed from the vehicle and replaced with compressed magnegas, resulting in a performance, measured in a dynamometer, that was essentially equivalent to that of compressed natural gas. This Honda Civic, which runs on compressed magnegas, was tested at U.S. Magnegas, Inc. in Largo, Fla. The excess energy release of 635 BTU/cf is due to the combination of the following three properties of the new chemical species of this invention:

1) Analytic tests on magnegas via infrared detectors or gas chromatograph have established that only approximately 70% of the H, C and O atoms in the above identified magnegas are bonded into H₂ and CO, while the remaining 30% of atoms are trapped uncoupled inside the magnecules constituting magnegas. At the time of the combustion, the magnecules break down, by therefore releasing said isolated atoms, which are then in condition to combine into said H₂ and CO molecules. Both of these reactions are highly exoenergetic. In fact, the formation of H₂ releases about 110 Kcal/mole while the formation of CO releases about 255 Kcal/mole. It is therefore evident that the formation of conventional molecules H₂ and CO at the time of breakdown of the magnecules caused by combustion provides a first contribution to the indicated excess energy release of 635 BTU/cf. In turn, such a contribution crucially depends on the existence of yet to be bonded isolated atoms in the magnecules, the existence of which is experimentally verified as shown below.

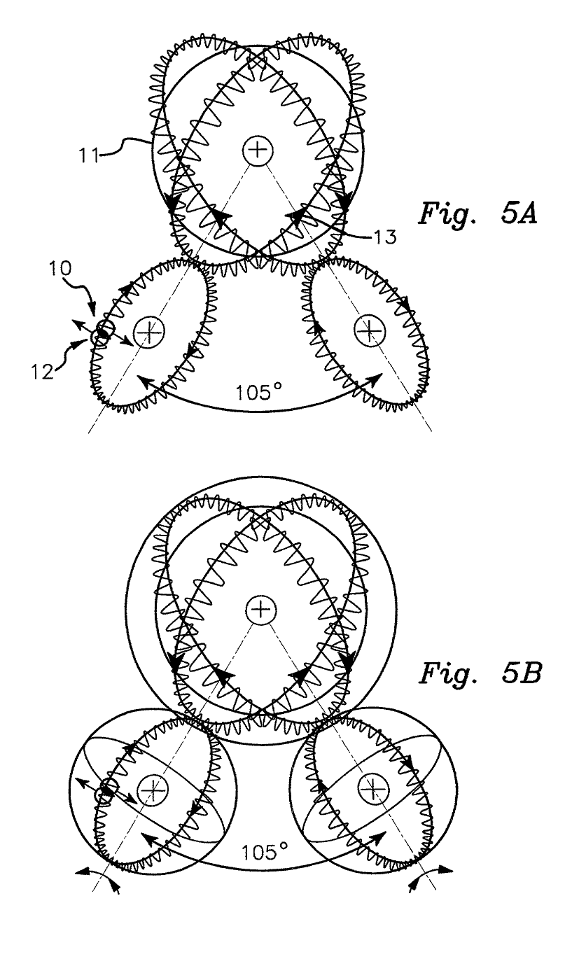

2) Once all magnecules have been eliminated, and magnegas is reduced to its conventional molecular composition, combustion of magnegas with atmospheric oxygen occurs according to conventional chemical reactions. Following various measurements, such a combustion produces an exhaust composed of about 50% H₂O, 15% O₂, 5% CO₂, the rest being composed of nitrogen and other atmospheric gases. Recent studies conducted by R. M. Santilli and D. D. Shillady, “A new isochemical model of the water molecule,” International Journal of Hydrogen Energy Volume 25, pages 173-183, 2000, have established that an essentially exact representation of all experimental data of the water molecule can be reached under the condition that the two pairs of valence electrons, one pair per each H—O dimer, are strongly correlated-bonded, resulting in a new model of the water molecule depicted in FIG. 5A. A visual inspection of the latter model establishes that exothermic chemical reactions, such as H₂+O−>H₂O+57 Kcal/mole, require for their occurrence a configuration of the orbits of atomic electrons suitable for valence bonds. In other words, when the electron of the hydrogen atom has a distribution in all directions in space, it is not ready for bonding with a corresponding electron of the oxygen. Therefore, according to the new structure model of the water molecule of FIG. 5A, the degrees of freedom of both valence electrons of the H and O molecules must be restricted to permit said valence bond into H₂O. After the creation of such a valence bond, rotational motions re-establish the conventional spherical distribution shown in FIG. 5B, although this time for coupled-correlated, rather than isolated valence electrons. The magnetic polarization at the foundation of this invention provides a configuration of peripheral atomic electrons in a form ready for their valence bonds with other electrons, as shown in the comparison of FIGS. 1C and 5A. It then follows that chemical reactions of the type H₂+O−>H₂O release more energy when occurring among magnetically polarized atoms as compared to the same reaction among atoms in conventional unpolarized conditions, e.g., because in a given mole of gas the former reactions are more statistically probable than the latter. In conclusion, a second contribution to the excess energy content of magnegas originates from an excess energy released by conventional chemical reactions caused by the polarized nature of the orbits of valence electrons of the individual atomic constituents, thus having in this way a configuration of the valence electrons ready for said chemical reactions, while such a configuration has to be created prior and in order to permit said chemical reactions for conventional magnetically unpolarized gases.

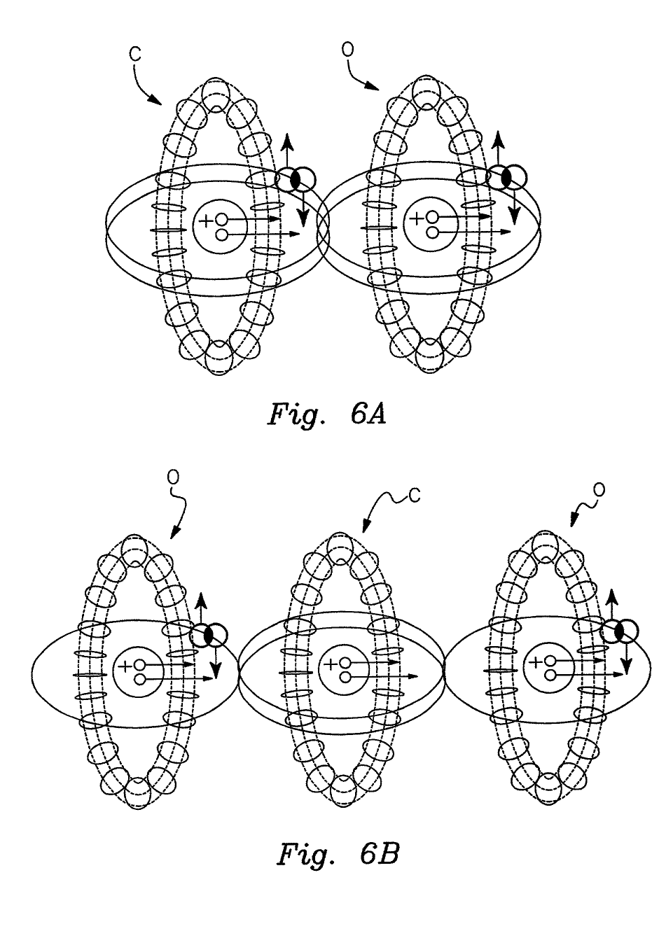

3) A third new contribution to the excess energy content of magnegas is due to the creation of new bonds of magnetic type in the interior of conventional molecules. Consider, as an example, the conventional unpolarized molecule CO with the usual double valence bonds for which it can be written C═O. The infrared signature of C═O shows two peaks which, as is well known, represent the two valence bonds of the considered molecule. It is also well known that each internal bond represents an internal storage of energy which can participate in ordinary exothermical reactions, such as CO+O−>CO₂. Experimental evidence, as discussed in further detail below, has established that a magnetic polarization of the molecule C═O can create a new internal bond which is established by the existence of a new peak in its infrared signature. This peak cannot evidently be an additional valence bond, since the four available valence electrons are all used in the double bond C═O. On the contrary, as shown in FIG. 6A, said new bond can indeed be of magnetic type and, more particularly, be due to a new attractive force among two opposite polarities North-South of the two magnetic polarizations South-North and South-North of non-valence electrons of the individual C and O atoms in the C═O structure. Along similar lines, and as illustrated in FIG. 6B, it is easy to see that, when exposed to sufficiently strong external magnetic fields, the conventional molecule CO₂=O—C—O can acquire two additional internal magnetic bonds. But, as indicated above, each peak in the infrared signature represents a bond with corresponding energy storage. It then follows that magnetically polarized molecules with additional peaks in their infrared signatures release more energy in thermochemical reactions than that released by unpolarized molecules, thus providing the above indicated third contribution to the excess energy content of magnegas.

By use the assumed symbols of “—” to represent valence bonds and “x” to represent magnetic bonds, a generic example of a gas magnecule is given by equation (7)

(H—H)x(O—O)xOx(C—H)x(H—O—H)xHx(C—O)xCx(H—H)x etc, (7)

in which the bonds are formed by chains of coupled opposing polarities North-South-North-South-North-etc. The above new chemical composition is the only possible explanation of how MS analyses of a light gas such, as the magnegas produced via a submerged electric arc, has stable detectable clusters all the way to 1,000 a.m.u., while the biggest possible cluster contained in such a light gas should be CO₂ with 44 a.m.u.

This latter feature has also been experimentally verified by measurements of the specific density of gases and liquids with a magnecular structure, which is greater than that of any combination of conventional molecular constituents. In turn, the increased density not only confirms the presence of magnecules, but also has important industrial and consumer applications. For instance, combustible fuels with a magnecular structure, not only have an energy release which is a multiple of the corresponding energy release for an ordinary molecular structure, but also the duration of use of a given volume at a given pressure of the fuel with a magnecular structure is a multiple of that of the same volume with the same fuel which only possess a conventional molecular structure.

In the case of liquids, molecules do not generally rotate on their center of gravity due to the intermolecular bonds existing within liquids. Accordingly, magnecules are more readily created in liquids than in gases. Moreover, the average atomic weight of the magnecules is larger than the average atomic weight of the individual molecular constituents and that of any of their possible combinations. This increased atomic weight, when combined with the increased energy output for thermochemical reactions, has important industrial and consumer applications.

As it is well know, the alarming environmental problems caused by gasoline combustion is stimulating the use of hydrogen as a fuel for internal combustion engines whose exhaust, as well known, is solely composed of water vapor. Despite that, hydrogen has the following serious environmental problems for automotive usage:

1) Hydrogen has the lowest energy content among all possible fuels, consisting of about 300 BTU/cf. Therefore, in its compressed form, hydrogen does not permit a sufficient duration of automotive use per each tank. For this reason, as proved by a car manufacturer BMW, Munich, Germany, and other automakers, the use of hydrogen as an automotive fuel requires its liquefaction, with consequential prohibitive safety problems in case of change of state, prohibitive costs as well as prohibitive logistic and technical problems for the liquefaction of hydrogen, delivering hydrogen in a liquefied state, and maintaining such a liquefied status in an automotive tank for an unspecified duration of time.

2) Hydrogen implies a reduction in power of about 35% as compared to the power, which can be obtained from the same engine when operating on gasoline. This occurrence has also been proved by the indicated BMW automobile which, when using gasoline, has about 340 HP, while it has only 220 HP when burning hydrogen.

3) Even though the combustion of hydrogen only emits water vapor, hydrogen has other serious environmental problems. In fact, when produced via regenerating methods, such as from natural gas, the combustion of hydrogen causes an alarming removal of breathable oxygen from our atmosphere, a very serious environmental problem called “oxygen depletion.” When hydrogen is produced via the electrolytic separation of water, the oxygen balance in our atmosphere between the production of hydrogen and its subsequent combustion evidently remains unchanged. However, when the electricity used for the separation of water originates from plants that generate a large amount of pollution, CO₂ emission and oxygen depletion, such as electric plants burning fossil fuels, the use of hydrogen as an automotive fuel becomes much more damaging to the environment on a global scale than the use of gasoline, for the evident reason that the production of gasoline is done via catalytic processes which do not require large amounts of electricity, while the exhaust of a contemporary car burning gasoline is dramatically less polluting on a global environmental basis than the automotive use of hydrogen produced via electricity originating from power plants burning fossil fuels.

As verified by U.S. Magnegas, Inc., a Florida corporation, by the conversion of one Ferrari and two Honda automobiles, the new chemical species of magnecules of this invention resolves all the above major problems.

To begin, the conversion of a conventional hydrogen gas into one with a magnecular structure permits the achievement of an increased energy density sufficient for an acceptable duration of automotive use with one tank of compressed gas, thus avoiding the expensive and dangerous liquefaction currently required for hydrogen. As an illustration, a Honda Civic available at the indicated U.S. Magnegas, Inc., has a range of about 2.5 hours when operating with one thousand cubic feet of magnegas compressed at about 3,600 psi, with range of the order of four hours for the use of a tank of the same size as the preceding one, but operating at 4,500 psi. These automotive ranges are amply sufficient for local commuting usage.

Second, as verified by a Ferrari 1980 model GTSI converted at U.S. Magnegas, Inc., to operate on magnegas, the increased energy output of magnecules under thermochemical reactions permits the achievement of a performance with compressed magnegas which is equivalent to that achieved with gasoline. This second important property has been verified by numerous tests performed at the Moroso International Track in West Palm Beach, Fla., via the indicated Ferrari 308 GTSi 1980 converted to operate on compressed magnegas and compared to similar cars operating on gasoline.

Third, conventional hydrogen gas cannot contain any appreciable percentage of oxygen to avoid possible self-combustion with consequential explosions. As a result, the automotive combustion of hydrogen can only be done via the depletion of breathable oxygen from our atmosphere. On the contrary, as also verified by U.S. Magnegas, Inc., an essentially pure population of magnecules primarily composed by hydrogen can indeed contain an appreciable percentage of oxygen without any risk of self-combustion or explosions due to the stability of the magnecules, thus reducing the depletion of breathable oxygen from our atmosphere. As an illustration, the above described converted automobiles operating on compressed magnegas, contain in the exhaust up to 14% of breathable oxygen, thus being the only known combustion exhaust capable of sustaining life. It should be noted that the oxygen content in magnegas does not originate from our atmosphere, but rather from the liquid waste used in its production, thus replenishing in this way the oxygen content of our atmosphere.

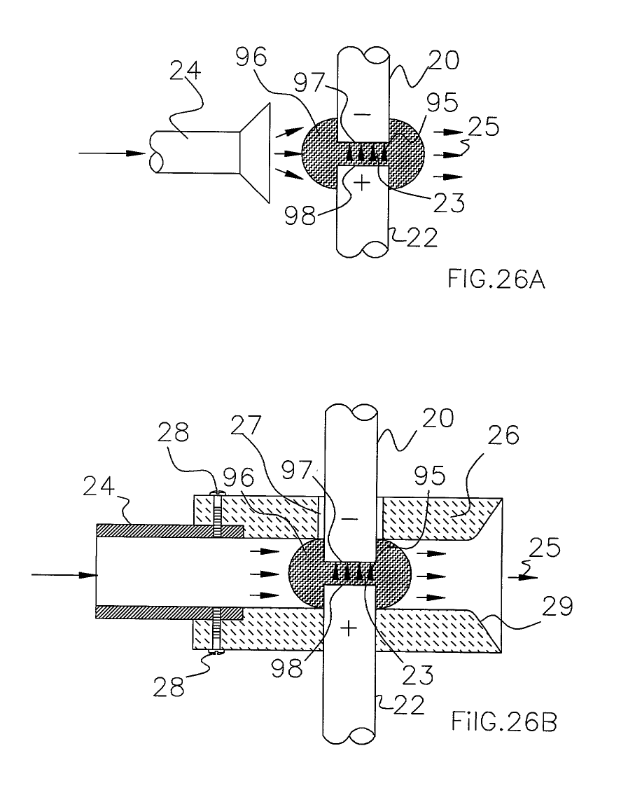

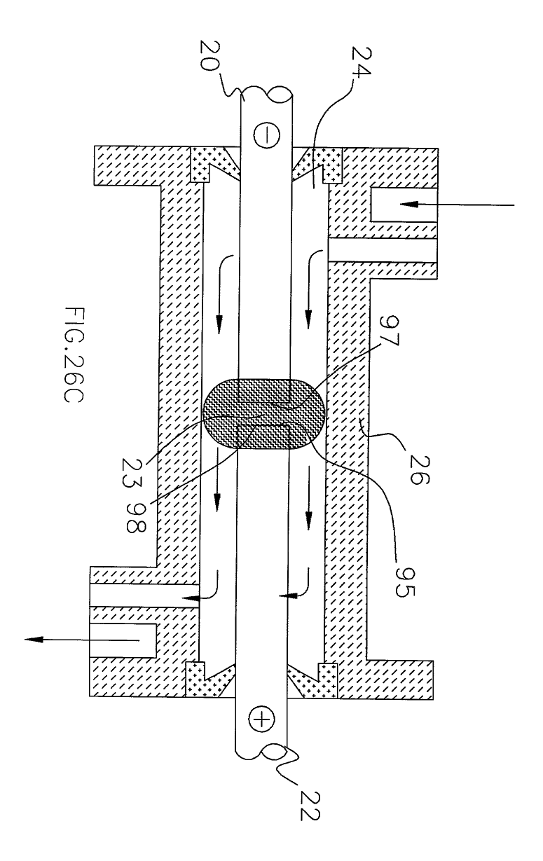

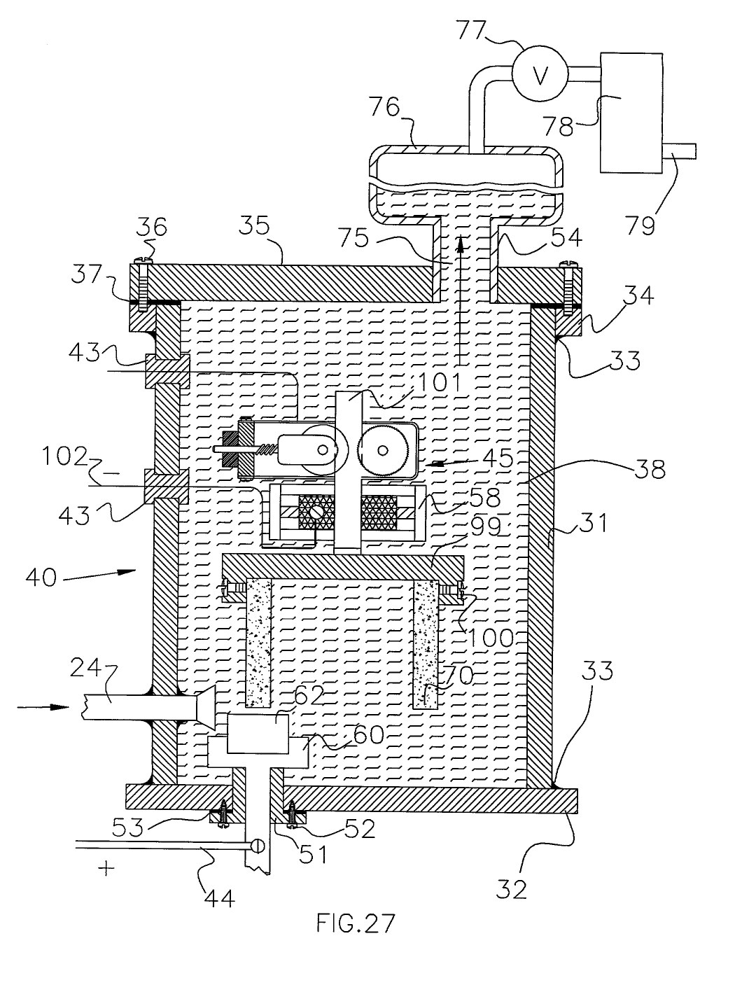

The most efficient device for creating an essentially pure population of magnecules suitable for industrial or consumer applications is the PlasmaArcFlow Reactor, as described in FIGS. 26 and 27. The PlasmaArcFlow Reactor forces a liquid waste to pass through an underliquid DC electric arc with at least one consumable carbon-based electrode, having, for instance, 1000 amps and 30 volts. With reference to FIGS. 26 and 27, the arc decomposes the liquid molecules and the carbon electrode by creating a plasma of mostly ionized atoms of hydrogen, oxygen, carbon and other elements. The flow of the liquid continuously moves the plasma away from the arc; the plasma cools down in the liquid surrounding the arc; ionized atoms re-acquire their electrons; a number of chemical and other reactions take place; magnegas bubbles to the surface of the liquid where it is collected while solids precipitate at the bottom of the liquid where they are periodically collected. In this way a liquid waste is recycled into the clean burning magnegas, heat acquired by the liquid, which heat is usable via a heat exchanger, and solids precipitating at the bottom of the reactor where they are collected.

As is known, magnetic fields are inversely proportional to the square of the distance at which they are detected. When the atomic constituents of molecules are exposed to magnetic fields created by the electric arc, that is, at distances of 10⁻⁸ cm, said magnetic fields are proportional to 10¹⁶ Gauss, thus having an intensity large enough to produce all possible magnetic polarizations. Atoms that are born under such maximal magnetic polarization then couple themselves via magnetic bonds, as well as valence bonds, resulting in an essentially pure chemical species of magnecules generally composed of molecules, dimers and individual atoms. In summary, as illustrated by the experimental evidence provided below, the use of an electric arc within a liquid waste, such as automotive antifreeze and oil waste, yields an essentially pure population of magnecules at the gaseous state without any appreciable content of molecules.

Magnecules can also be formed by a variety of other means. For instance, magnecules can be produced by electromagnetic fields, which can cause a polarization essentially as in the case of an electric arc. Magnecules can also be formed by microwaves capable of removing the rotational degrees of freedom of molecules or atoms, resulting in magnetic polarizations, which couple to each other. Similarly, magnecules can be formed by subjecting a material to a pressure that is sufficiently high to remove the orbital rotations. Magnecules can also be formed by friction or by any other means not necessarily possessing magnetic or electric fields, yet capable of removing the rotational degrees of freedom within individual atomic structures, resulting in consequential magnetic polarizations.

The destruction of magnecules is achieved by subjecting the essentially pure population of magnecules to a temperature greater than the magnecules' Curie Temperature, which varies from magnecule to magnecule.

Magnecules have several characteristics that uniquely identify them as a new chemical species, among which we note:

1) inability to identify the peaks of magnecules in GC-MS analyses via computer searches among all known molecules;

2) lack of infrared signature for gases, lack of ultraviolet signature for liquids, and lack of other signatures for solids, except those of the conventional molecules or dimers constituting the magnecules;

3) average density greater than the average density of all molecular constituents or any of their combinations;

4) presence in the magnecules of individual unbounded dimers and/or atoms;

5) appearance in the infrared signature of the molecules constituting the magnecules of new peaks denoting a new internal bond with a consequential new means of storing energy;

6) energy released in thermochemical reactions due to the formation of conventional molecules at the time of the break-down of the magnecules which is generally a multiple of the energy released by conventional molecular constituents;

7) energy produced by conventional exothermic reactions for magnetically polarized molecular constituents of magnecules which is also a multiple of the energy released by chemical reactions for unpolarized molecular constituents;

8) alteration in time, called mutation, of the MS peaks representing the magnecules due to collisions, break down of some of the magnecules, and consequential formation of other magnecules, or just accretion of smaller magnecules or molecules or dimers, or atoms;

9) alteration, called mutation, of generally all conventional physical characteristics, such as viscosity, transparency to light, index of refraction, etc.;

10) adhesion to walls of containment chambers which is much greater than that of the same unpolarized substance due to the well-known property that magnetism can be propagated by induction;

11) absorption or penetration through other substances which is much greater than those of the same unpolarized gas; and

12) termination of all of these unique characteristics at a sufficiently high temperature called Curie Temperature.

Since magnecules have properties very different from those of conventional molecules the experimental detection of magnecules requires special care. In particular, methods which have been conceived and constructed for the detection of molecules are not necessarily effective for the detection of the different chemical species of magnecules precisely in view of the indicated unique characteristics. For instance, GC-MS equipment, which is very effective for the detection of conventional molecules is basically insufficient for the detection of magnecules because of the crucial requirement indicated earlier that every peak in the MS should be jointly inspected in the IR, thus requiring the necessary use of GC-MS equipped with IRD. A molecule can be claimed to occur in magnetically polarized substances only following a dual identification, first, via a peak in the MS and second, a verification that such a peak admits the IR signature precisely of the claimed molecule. A magnecule occurs when both identifications are missing, namely, the MS peak cannot be identified by computer search and comparison among all existing molecules, and the peak has no IR signature other than those of the much lighter molecules and/or dimers constituting the magnecule.

In addition, numerous other precautions in the use of the GC-MS equipped with IRD are necessary for the detection of magnecules, such as:

i) the MS equipment should permit measurements of peaks at ordinary temperature, and avoid the high temperatures of the GC-MS column successfully used for molecules;

ii) the feeding lines should be cryogenically cooled;

iii) the GC-MS/IRD should be equipped with feeding lines of at least 0.5 mm ID with larger feeding lines for LC-MS/UVD;

iv) the GC-MS should be set to detect peaks at atomic weights usually not expected; and

v) the ramp time should be the longest allowed by the GC-MS/IRD and be of at least 25 minutes.

It should be stressed that the lack of verification of any one of the above conditions generally implies the impossibility to detect magnecules. For instance, the use of a feeding line with 0.5 mm ID is excessive for a conventional light gas, while it is necessary for a gas with magnecular structure such as magnegas. This is due to the unique adhesion of the magnecules against the walls of the feeding line, resulting in an occluded feeding line which prevents the passage of the most important magnecules to be detected, those with large magnecular weight.

Similarly, it is customary for tests of conventional gases to use GC-MS with columns at high temperature to obtain readings in the shortest possible time, since conventional molecules are perfectly stable under the temperatures here considered. The use of such method would also prevent the detection of the very quantities to be detected, the magnecules, because, as indicated earlier, they have a characteristic Curie Temperature varying from case to case at which value all unique magnetic characteristics are terminated. Magnecules are stable at ordinary temperatures and, consequently, they should be measured at ordinary temperatures.

Along similar lines, recall that a GC-MS with a short ramp time is generally used for rapidity of results. Again, the use of such a practice, which has been proven by extensive evidence to be effective for molecules, will prevent clear detection of magnecules. In fact, if the ramp time is much less than 25 minutes, e.g., it is of the order of one minute, all the peaks of magnecules generally combine into one single large peak, as verified below. In this case the analyst is generally lead to inspect an individual section of said large peak. However, in so doing, the analyst identifies conventional molecules constituting the magnecule, and not the magnecule itself. When these detectors with short ramp times are equipped with IRD, the latter identify the infrared signatures of individual conventional molecules constituting said large peak, and do not identify the possible IR signature of the single large peak itself. Therefore, a GC-MS with short ramp time is basically unsuited for the detection of magnecules because it cannot separate all existing peaks into individual peaks, but groups them all together into one single large peak which is unidentifiable as a whole, resulting in the generally erroneous opinion that the chemical composition considered is that of conventional molecules without sufficient scientific evidence.

The test of a gas with magnecular structure via a GC-MS and, separately, via an IRD is also grossly misleading and improper. This is due to the well known, general tendency to identify a peak in the MS with a conventional molecule which, at times, may be also present in the separate IRD test, leading to a potentially erroneous conclusion of conventional chemical composition because, as it is well known, IRD do not detect complete molecules, but only their dimers. However, unlike the case for the conventional molecules, dimers can be constituents of magnecules. Therefore, the sole identification of a dimer in the IRD not connected to the GC-MS is, by no means, evidence that the corresponding molecule exists in the gas considered.

A typical illustration is given by the detection in a GC-MS without IRD of a peak at 44 a.m.u. which is generally assumed to be CO₂. The separate IR test of the same gas may indeed yield the characteristic signature of carbon dioxide, thus leading to the opinion that the peak here considered is the CO₂. In reality, the IRD has only detected in this case the C—O dimer, while the MS peak at 44 a.m.u. may be due to the magnecule (C—O)x(H—H)x(H—H)—C which has indeed atomic weight 44 a.m.u. while admitting indeed the IR signature of CO₂. This ambiguity is due to the fact that, in the case here considered, the IR test is done separately from the MS test. On the contrary, the same ambiguity does not exist for GC-MS equipped with IRD because, in the latter case, the equipment can be restricted to the sole detection of peaks in the vicinity of 44 a.m.u. at both the MS and the IR modes. The lack of MS identification of the peak at 44 a.m.u. in this case establishes beyond doubt that the peak with 44 a.m.u. here considered cannot possibly be a molecule.

Similarly, peaks with 18 a.m.u. are generally associated with the water molecule H—O—H. Such an interpretation may be correct for the case of conventional, magnetically unpolarized gases. However, for the case of magnegas the interpretation is generally erroneous because the peak at 18 a.m.u. may have no infrared signature when tested with a GC-MS equipped with IRD, and the indicated atomic weight can be reached via the magnecule (H—H)x(H—H)xCx(H—H).

In conclusion, the experimental evidence of the above occurrences, as outlined below, establishes the need in the detection of gas magnecules of avoiding, rather than using, techniques and equipment with a proved efficiency for molecules, thus avoiding the use of GC-MS without IRD, with short ramp time, high column temperatures, feeding line with a small section, and other established techniques. On the contrary, new techniques specifically conceived for the detection of magnecules should be worked out.

The conditions for scientific measurements of magnecules in liquids are essentially the same as those for gas magnecules, except for the use of LC-MS/UVD, rather than GC-MS/IRD. Liquid magnecules possess similar properties and characteristics and require similar detection conditions as those needed for gases, with particular reference to increased size of feeding lines and columns.

The magnecules of the present invention are producible by the equipment disclosed in U.S. Pat. No. 6,183,604 B1, which is incorporated herein by reference in its entirety. With reference to FIG. 27, the embodiment of the above patent is based on a hollow, cylindrical shaped, carbon based anode rotating edgewise against a stationary tungsten based cathode. Additional means of producing the magnecules of the present invention are disclosed herein. With reference to FIGS. 26A, 26B and 26C, a preferred embodiment of the additional means is essentially that of FIG. 27 in which the electrodes are constituted by two carbon based cylindrical rods. More particularly, the flow of the liquid through the arc can indeed occur for the configuration of the electrodes of FIG. 27 or the solid rod shaped electrodes as in the configuration of FIG. 26A. On the contrary, the flow of the arc as in FIGS. 26B and 26C requires a containment of the arc itself described below, which containment is more adequately permitted by the rod shaped electrodes of FIGS. 26B and 26C, as compared to the hollow cylindrical configuration of the cathode of FIG. 27.

In conclusion, the flow of the liquid through the arc, which permits the production of an essentially pure population of magnecule, as described below can be realized with a variety of electrodes. The first and simplest embodiment is that of FIG. 26A in which the flow occurs through an unrestricted arc. In this case the arc can be that of the configuration between the electrodes of FIG. 27, or of FIG. 26A, or of other shapes of the electrodes. Other embodiments demand the enclosure of the arc itself within an area specified below. In this case the electrodes of FIG. 27 should be modified into the rod shape forms of FIGS. 26B and 26C, while the rest of the equipment remains unchanged. The latter simple replacement is tacitly implied below whenever needed.

In particular, as shown in FIG. 26A two electrodes 20, 22 of about ¾″ in diameter are immersed within water or a liquid waste to be recycled. The liquid is contained in the interior of a metal vessel, as shown in FIG. 27, surrounding electrodes 20, 22, each consisting of a 1″ diameter carbon-based rod. A DC electric arc 95 is made to occur in between the tip 97 of the anode 20 and the tip 98 of the cathode 22, the electrons moving from the negatively charged tip 98 toward the positively charged tip 97, said electric arc 95 being powered by a 75 kwh DC power source (not shown) with a gap 23 designating the distance between the tips 97, 98 of the electrodes 20, 22 which is generally of the order of ⅛″ for a 75 kWh DC power source and a related electric arc with 1,500 A and 33 volts.

FIG. 26A also depicts the plasma 96 surrounding the tips 97, 98 of the electrodes 20, 22, which essentially consists of an area having the natural geometry of a spheroidal ellipsoid with semiaxes of about ¾″×¾″×1″½″ created by the incandescent character of the tips 97, 98 under the electric arc 95, and generally composed of a mixture of gaseous and liquids components at a temperature the on order of 10,000° C. The recycling of the liquid waste occurs by flowing the liquid via a pump, not shown, forcing the liquid through pipe or tube 24 thus forcing the liquid to pass through the plasma 96 surrounding the tips of the electrodes 20, 22 and through the electric arc 95 with gap 23, and then ending with the outlet flow 25. This embodiment constitutes the PlasmaArcFlow process, which decomposes the molecules of the liquid to be recycled into gaseous and solid elements. The recombination of the gaseous elements into a combustible gas is controlled by the flow itself, while solids precipitate at the bottom of a reactor where they are periodically collected for industrial and other usages.

A further embodiment is depicted in FIG. 26B, which comprises the same electrodes 20, 22, related tips 97, 98, related gap 23, the electric arc 95 through said gap 23, the plasma 96, and the 75 kWh DC power unit (not shown). The liquid to be recycled is forced to move by a pump, not shown, through tube 24 which ends in a tube 26 of insulating material, such as ceramic, hereinafter called venturi, which has the following main features: 1) the venturi 26 encompasses the tips 97, 98 of the electrodes 20, 22; 2) the venturi 26 has the approximate interior diameter of about 1″½″ for electrodes with 1″ diameters, about 3″ in outside diameter, and about 5″ in length; 3) the venturi 26 has 1/16″ clearance 27 for the electrodes 20, 22 to move freely in and out the venturi 26; 4) the venturi 26 is locked into the tube 24 by fasteners, such as screws 28; and 5) the venturi 26 ends with a smooth curve 29 to minimize turbulences. After being forced to pass through said venturi 26, the liquid waste then exits with outlet flow 25.

The PlasmaArcFlow according to the venturi 26 of FIG. 26B permits the recycling of liquid waste, which attains full sterilization with one single pass when using the venturi 26 of FIG. 26B. In fact, as shown in FIG. 26B the entire liquid sewage is forced to pass through the plasma 96 having 10,0000° F., plus an extremely intense light, electric current of 1,500 A and more, very large electric and magnetic fields, all factors which assure the instantaneous termination of all bacteriological activities.

The proportionately larger interior diameters of the venturi 26 are needed for larger electrode diameters; the interior shape of the venturi 26 can have a variety of geometries, such as an ellipsoidal, rather than a cylindrical, sectional area; and the end shape of the venturi 26 can have a variety of different curves to minimize turbulences.

FIG. 26C depicts a third preferred embodiment of the PlasmaArcFlow equipment for the production of an essentially pure population of magnecules at both the gaseous and liquid states. This third embodiment consists of a venturi 26 in the shape of a cylinder with 1.250 inches internal diameter, 2 inches exterior diameter and 12 inches in length constructed from an insulating material such as phenolic or ceramic and ending with two flanges on each end for attachment to the rest of the embodiment described below, plus one port for the entrance of a liquid and a second port for the exist of the same. Two carbonaceous electrodes, 20, 22 each of 1 inch in diameter and 24 inches in length, are placed in the interior of venturi 26 in such a manner that: 1) the rods 20, 22 and the venturi 26 have the same cylindrical symmetry axis; 2) there is a 0.125 inches thick empty cylindrical interspace between the carbonaceous rods 20, 22 and the interior of the venturi 26; 3) the rods 20, 22 are sealed at each of the two ends of the venturi 26 so as to avoid escape of the liquid being pumped through; 4) an electrical connection of each of the two electrodes 20, 22 to each polarity of a DC generator with 75 kWh (not shown); and 5) the position of the electric arc is within anywhere of 12 inches in length of the venturi 26.

The assembly is then completed in the reactor of FIG. 27. Any one of the PlasmaArcFlow assemblies of FIG. 26A, 26B and 26C may be placed in the reactor of FIG. 27, with the inlet and outlet of said venturi 26 being connected to a recirculating pump for the flow of a liquid in the interior of venturi 26, a DC power unit of 75 kWh, automatic means for the initiation and control of the arc, means for the collection of the gas produced in the interior of the reactor, means for the utilization of the heat produced by the reactor as acquired by the liquid, and other components of FIG. 27 identified herein.

The vessel of FIG. 27 is filled up with a liquid, such as ordinary tap water, or a liquid waste, such as automotive antifreeze or oil waste, which liquid is forced by the recirculating pump to pass through the indicated 0.125 inch space in between the carbonaceous rods and the interior wall of the venturi 26 while the DC electric arc is operating. The incandescent tips of the electrodes then decompose some of the liquid molecules, exposing the individual atoms to the extremely high magnetic fields of the electric arc which, for a 75 kWh DC arc can be as high a ten Tesla and more at molecular distance from the electric arc, and create a plasma in the surrounding area of the tips of the electrodes composed of highly polarized atoms of hydrogen, oxygen and carbon as occurring in the other two PlasmaArcFlow embodiments of FIG. 26A and 26B.

The flow of the liquid through the venturi 26 continuously removes the plasma following its formation, resulting in a combustible gas, called magnegas, which is composed of an essentially pure population of gas magnecules. The recirculation of the liquid through the arc for the duration of 1 hour for a 75 kWh DC electric arc and 25 gallons of the recirculating liquid create an essentially pure population of liquid magnecules. Much shorter periods of recirculation of the liquid are needed for proportionately larger DC power units. For instance, an essentially pure population of 25 gallons of liquid magnecules can be formed in 10 minutes via the venturi 26 of FIG. 26C and 150 kWh DC power unit.

The main difference between the embodiment of FIG. 26C and the preceding two embodiments of FIGS. 26A and 26B is that, as shown in FIGS. 26A and 26B the flow of the liquid is perpendicular to the symmetry axis of the carbonaceous rods, while in the embodiment of FIG. 26C the flow of the liquid is parallel to the cylindrical symmetry axis of, as well as surrounding the exterior of the carbonaceous rods, to provide the production of an essentially pure population of gas and liquid magnecules from an electric arc.

The achievement of an essentially pure population of magnecules by the embodiments of FIGS. 26 and 27 is proven and verified by the spectroscopic data provided herein. Specifically, the peaks detected by the MS scans remain unidentified following a search among all molecules, and the peaks have no infrared or ultraviolet signature, respectively, this confirming the lack of valence bonds as discussed herein.

By comparison, the embodiments of the prior art, such as that according to U.S. Pat. No. 5,487,874 (the '874 patent) dealing with an electric arc within the chamber of an internal combustion engine may produce gas magnecules. Any gas magnecules so produced are present in minute amounts in comparison to conventional molecules present so as not to be detectable by available GC-MS analyzers. More particularly, the magnecules, which may be created by such an embodiment, are so small in number that they do not emerge from the background noise of the analyzing instrument. This is due to the dramatic numerical differences between the embodiments of the '874 patent and the present invention. First, the arc of the '874 patent occurs within a gas while it occurs within a liquid in the embodiment of this invention. The transition from liquid to gas provides the transition from unit volume of the liquid to 1,800 units of volume of the gas at atmospheric pressure. The compression in the combustion chamber of an engine results in a ratio of the densities of matter in the embodiment of the '874 patent and the present invention on the order of 1,500. This difference explains the creation of mere traces of magnecules in the embodiment of the '874 patent and definitely is not an essentially pure population of magnecules.

Moreover, sparks of internal combustion engines are notoriously limited in the amount of electric energy they can use for various reasons related to arcing, safety, etc. In fact, the DC spark in the engine of ordinary cars has about 15,000 V and 100 milliamps, resulting in about 150 W. By comparison, the embodiment of this invention can use up to 75,000 W in the case of 1 inch carbonaceous rods, with virtually unlimited larger values of the electric power for proportionately larger carbonaceous rods. Since the creation of magnecules is directly dependent on the electric energy, this second dramatic difference in numerical values between the prior art and the present invention further establishes that the prior art can only create traces of magnecules, while the present invention produces an essentially pure population of magnecules.

The third and most important numerical difference between the prior art and this invention is due to the fact that the electric arcs of pre-existing embodiments are stationary, and, for the case of the '874 patent pulsating and stationary, while the embodiment of this invention provides the flowing of the plasma through a continuous arc. More specifically, in the '874 patent traces of magnecules can only be created in the immediate vicinity of the spark itself, because immediately thereafter there is combustion. By contrast, the DC electric arc of the present invention does not cause any combustion, and, therefore, operates continuously. Moreover, the PlasmaArcFlow continuously removes the plasma full of magnecules immediately following its creation, thus permitting a continuous creation of magnecules. Further, the spark in an internal combustion engine has the duration on the order of one nanosecond and the frequency of about 5,000 sparks per minute, while the arc of the present invention is continuous, such a difference provides an efficiency in the production of magnecules in the present invention which is at least 1,000,000 times that of the '874 patent.

A similar situation exists for liquid magnecules. However, as is made clear from the above discussion, the prior art can at best create traces of magnecules in such small numbers as not to be detectable with available LC-MS/UVD equipment. The present invention provides for the first time an essentially pure population of liquid magnecules via the embodiments of FIGS. 26 and 27, namely, via the continuous forcing of a liquid through a continuously running electric arc.

All embodiments of the present invention also work for AC electric arcs, although the efficiency in the production of the combustible magnegas is in this case reduced due to the reversal of the arc itself with a frequency equal to that of the AC current.

As shown in FIG. 27 the PlasmaArcFlow reactor is composed by the following main parts:

MAIN CLOSED VESSEL ASSEMBLY, collectively denoted 40 comprising a vertical steel cylindrical sidewall 31 of about 1″ thickness, about 3′ external diameter and about 7′ height, with base 32 consisting of a steel disk of 2″ thickness and 3′ and 1″ in outside diameter fastened to sidewall 31 via high pressure resistant continuous welding 33, the vessel being additionally completed by the steel flange 34 of 2″ thickness and 3′ 3″ in outside diameter fastened to said sidewall 31 via high pressure resistant continuous welding 33, plus a top 35 composed by a steel disk of 2″ in thickness and 3′ and 3″ in outside diameter, which is fastened into the flange 34 via bolts 36 or other means, gasket 37 assuring the complete sealing of the interior chamber in such a way to sustain high pressure, said closed metal vessel being completely filled with the contaminated liquid waste 38 to be recycled.

ELECTRODES ASSEMBLY, comprising the stationary nonconsumable cathode 62 composed by a tungsten rod of at least 2″ in outside diameter and 3″ in length, housed in a copper holder 60 which protrudes below and outside the base of the vessel and it is insulated electrically from the same base by the nonconducting bushing 51, fastened to the base by screws 52, gasket 53 ensuring the complete sealing under pressure of the main vessel, said busing 51 being made of phenolic or other electric insulator in the shape and dimension so as not to allow any distance less than 1″ between the cathode holder 60 and the metal base; plus a consumable anode 70 made of carbon, coal or other conducting material, in the shape of a cylinder having the thickness of ¾″, the radius of one foot, and the height of 3′, said cylindrical anode 70 being housed inside a copper cup 99 holding the cylindrical anode 70 with fasteners 100, the assembly of the cylindrical anode 70 and its copper holder 99 terminating in the upper part into a copper rod 101 of ¾″ in diameter and height longer than the consumable length of the cylindrical anode 70, e.g., 4′ height, the copper rod 101 passing through a contact assembly 58 for the delivery of the electric current with negative polarity, the negative polarity being delivered by high current electric wires 102 while the electric current with the positive polarity is delivered to the copper holder 60 of the cathode 62 in its part protruding outside and below the base. An alternative selection of the electrodes is given by electrodes composed of cylindrical shape, carbon based, solid rods with 1″ outside diameter acting edgewise one against the other as in the configurations of FIGS. 26A, 26B, and 26C.

PLASMA-ARC-FLOW ASSEMBLY, can be any one of the assemblies shown in FIGS. 26A, 26B and 26C and may be served by a recirculating pump (not shown). As indicated earlier, whenever using a venturi, the replacement of the electrodes of FIG. 27 with those of FIGS. 26B and 26C is assumed. Otherwise, when using a PlasmaArcFlow on an open arc as in the configuration of FIG. 26A, the electrodes can be those of FIG. 26A, or those of FIG. 27, or have any other desired geometry.

ELECTRIC POWER ASSEMBLY, comprises a 50 kWh or greater DC electric generator, such as those available from Miller Corporation, with high current copper cable 102 to deliver the negative polarity to the interior contact assembly and copper cable 44 for the delivery of the positive polarity to the cathode holder 60 protruding below and outside the base of the vessel, and automatic feeder 45 for the initiation, maintaining and optimization of the electric arc. The automatic feeder 45 has the capability of rotating the copper rod 101 of the cylindrical anode 70 at the speed of 5 r.p.m. in addition to its motions along the rod axis, so as to permit the rotation of the cylindrical anode 70 over the cathode 62, in addition to the motion of the cylindrical anode 70 toward and away from the stationary cathode 62.

The operation of the preferred embodiment of the high pressure PlasmaArcFlow reactor of FIG. 27 is as follows: the cylindrical carbon or coal anode 70 is inserted into its copper holder 99 and placed in the position suitable to initiate the arc; the closed reactor vessel is filled up completely with the liquid waste 38 to be recycled, such as automotive antifreeze waste or engine oil waste or crude oil; the reactor is then primed with magnegas for the complete removal of atmospheric oxygen in the interior of the vessel; the PlasmaArcFlow and heat utilization pumps are activated; the automatic feeder 45 of the electric arc is initiated at a distance from the equipment or via computer sequence; the cylindrical carbon or coal anode 70 initiates rotation edgewise with respect to the tungsten cathode 62, while advancing also head-on until the electric arc is initiated; as the carbon or coal is consumed by the electric arc at one point of the edge of the cylinder anode 70, the rotation of the latter, plus its micrometric downward motion when needed, permit keeping constant the electric voltage of the arc, thus maintaining constant its gap; magnegas is immediately produced following the initiation of the electric arc, jointly with the production of heat in the liquid; operation initiates at atmospheric internal pressure, and rapidly increases with the production of magnegas to the preset pressure of the gauge-valve assembly 77; all magnegas produced in excess of said pre-determined pressure is then permitted to exit the reactor and be pumped into conventional storage tanks.

The high pressure PlasmaArcFlow reactor in the embodiment of FIG. 27 requires the periodic replacement of the cylindrical carbon or coal anode 70 every approximately 8 hours of work for the cylinder dimensions given above. Such replacement can be realized via means for fast removal of the top of the vessel and fast reloading of the new cylinder anode.

To understand the duration of the cylindrical anode, recall that a ¾″ carbon or coal rod is consumed at the rate of about ½″ per cubic foot. A cylindrical anode with ¾″ thickness, 1′ radius and 3′ height is the equivalent of 300 linear rods of ¾″ in diameter and 12′ length, thus being useful for the production of 7,200 cubic feet of magnegas which, at the rate of 900 cf/h lasts for 8 continuous working hours, as indicated. Longer durations of the cylindrical anode can be easily accommodated by increasing its radius, or its height or both. A sufficiently larger vessel can, therefore, be designed to work continuously for 24 hours, then halt operation for the rapid replacement of the cylindrical anode, and then resume operations immediately thereafter.

The high pressure PlasmaArcFlow reactor of FIG. 27 has an efficiency that is dramatically greater than that of low pressure reactors, because the production of magnegas in the electrodes gap displaces the liquid waste to be recycled, as a consequence of which the electric arc occurs for the majority of the time, estimated to be 60%, within the magnegas produced, rather than within the liquid.

By comparison, when operated at pressures on the order of 200 or 300 psi, the bubbles of magnegas produced by the electric arc are dramatically reduced in size by at least 99%. Accordingly, the electric arc occurs for the majority of the time within the liquid to be recycled, thus dramatically increasing the production of magnegas, with a corresponding dramatic increase in the heat produced.

Detailed calculations based on hadronic mechanics, hadronic superconductivity, and hadronic chemistry, estimate that the over-unity of the high pressure PlasmaArcFlow reactor of FIG. 27, when operating at 300 psi, is at least 30, of which an over-unity of 10 is expected for the production of magnegas, and an over-unity of 20 is expected in the production of usable heat.

As is known, electric generators have an efficiency of 30%, the efficiency of the high pressure hadronic reactor of FIG. 27 is self-sustaining, in the sense that the magnegas produced is sufficient to power an electric generator for the production of the DC electric current needed to operate the hadronic reactor itself, and then remaining with sufficient magnegas to be used for other purposes, in addition to the production of a large amount of usable heat.

An alternative embodiment of FIG. 27 is one in which the negative polarity of the electric current is delivered via copper bushing sliding on the exterior cylindrical surface of the anode 70 at about 1″ distance from its lower edge and positioned as close as possible to the electric arc to minimize losses of electric energy due to the high resistance of carbon. In this alternative embodiment the anode 70 has an outside diameter of 2′, and the anode driving assembly drives the copper rod or shaft 101 of the anode 70 and contains an additional means for rotation while advancing. The main advantage of this alternative embodiment is a substantial savings of electric energy. In fact, for the embodiment of FIG. 27 the electric current has to pass through the entire length of the cylindrical anode, with considerable losses due to known resistance of carbon which is about 300 times the resistance of copper. By comparison, the latter embodiment allows the delivery of the current very close to the arc, thus avoiding the preceding waste of electric energy.

Individual substances can be removed from, magnegas via chemical or other means while preserving the remaining magnecular structure. An illustration is given of the removal of carbon monoxide from magnegas, resulting in a carbon-free version of magnegas, which is essentially given by hydrogen with an essentially pure magnecular structure, called “maghydrogen.” The magnecular structure is preserved as proven by measurements of average weight, which is up to 20 a.m.u., which is up to ten times the weight of a conventional hydrogen gas. Accordingly, maghydrogen is preferable over conventional hydrogen in all its fuel applications, with particular reference, but not limited to the use of maghydrogen as a fuel for internal combustion engines and fuel cells. In fact, measurements conducted at U.S. Magnegas, Inc., of Largo, Fla., prove that a given volume of maghydrogen at a given pressure lasts at least ten times longer than the same volume of conventional hydrogen at the same pressure, while having an increase in energy output in cars or an increase in efficiency in fuel cells of at least 10% due to the reasons indicated above, including the additional energy storage in magnecules or a better geometric readiness of the polarized gas for valence bonds in combustion as compared to conventional hydrogen gas.

The PlasmaArcFlow reactors depicted in FIGS. 26 and 27 can also be used by replacing the liquid in the vessel with a gas, provided that the equipment is suitably modified to withstand interior gas pressures of at least 10,000 psi. This is readily possible because, for the treatment of gases, there is no need for carbon-based electrodes, which can therefore be nonconsumable such as those made of tungsten. Accordingly, there is no longer any need for the electrodes to penetrate into the vessel, or for the vessel to have an opening for the removal of the magnegas produced when operating with liquids. As a result, the vessel of FIG. 27 can be completely sealed, thus readily suitable to withstand 10,000 psi of internal pressure or more.

In this latter embodiment the gas with a conventional molecular structure is turned into one with an essentially pure magnecular structure following the operation of the PlasmaArcFlow reactor for a duration of time dependent on the electric power of the reactor, as well as the gas selected. For instance, 75 kWh DC power unit with an electric arc having 1,500 A and 33 V can create a magnecular structure in 10 cubic feet of a conventional hydrogen at atmospheric pressure compressed to 10,000 psi in about 15 minutes of operation.

The advantages of the creation of a magnecular structure in a given gas are evident; are based on the desired specific features of magnecules; and their selection depends on the specific application. For instance, a magnecular structure is advantageous when the specific application at hand requires an increased atomic weight, or an increased adhesion, or an increased solution within liquids.

One application of particular industrial, consumer and environmental interest is the creation in the PlasmaArcFlow equipment identified above of oxygen with an essentially pure magnecular structure, called “magoxygen.” Again, this particular form of oxygen is created by using a PlasmaArcFlow reactor modified to withstand at least 10,000 psi, and then continuously recirculating the oxygen through one of the venturies of FIGS. 26A, 26B or 26C operated by a continuous arc between nonconsumable tungsten electrodes with DC 75 kWh electric power, yielding an arc with 1,500 A and 33 V. In this case 100 cubic feet of oxygen can acquire an essentially pure population of magnecules in about 30 minutes of operation, with evident shorter operating times for bigger electric powers.

As it is well known in the art, oxygen is paramagnetic. Therefore, oxygen is particularly suited to acquire a magnecular structure either in its pure state, as here considered, or in combination with other gases. Moreover, such a paramagnetic characteristic implies lesser treatment times of oxygen as compared to other diamagnetic gases.

Magoxygen is important in combustion. As indicated above, the combustion of maghydrogen provides an increase of energy output or efficiency of at least 10% as compared to the energy output or efficiency, respectively, of the combustion of conventional hydrogen, resulting in a total increase of 20% of energy output, which is significant and important for the fuel cells industry.

In conclusion, subject to the modifications identified above, PlasmaArcFlow reactors produce an essentially pure population of magnecules by filling up the vessel either with liquids or with gases. Accordingly, the substance contained in the PlasmaArcFlow reactor shall hereinafter referred to as a “fluid” in its traditional meaning of denoting either a liquid or a gas.

The following experimental evidence establishes the scientific and industrial validity of the present invention and is not meant in any way implicitly or intentionally to restrict the scope of the invention. These experimental results unequivocally establish the existence of magnecules in gases, liquids and solids, as well as establish each of their unique features. All experimental verifications have been conducted several times. In the following we outline, for brevity, only two out of the several verifications available per each individual feature of magnecules. Further, all tests were conducted at independent laboratories identified below per each test, which laboratory had no affiliation of any type to the inventor and/or any of his associates.

The first experimental detection of magnecules via GC-MS/IRD occurred at the McClellan Air Force Base in North Highland, Calif. via measurements conducted on a sample of magnegas. The measurements were conducted on an HP GC model 5890, an HP MS model 5972, and an HP IRD model 5965 attached to the GC-MS. In particular, the equipment was set for the analytic method VOC IRMS.M utilizing an HP Ultra 2 column 25 m long with a 0.32 mm ID and a film thickness of 0.52 μm. The analysis was conducted from 40 a.m.u. to 500 a.m.u. The GC-MS/IRD was set at the lowest possible temperature of 10° C.; the largest possible feeding line having an ID of 0.5 mm was installed; the feeding line itself was cryogenically cooled; the equipment was set at the longest possible ramp time of 26 minutes; and a linear flow velocity of 50 cm/sec was selected. Background measurements of the instrument were taken prior to any injection of magnegas. The instrument was also inspected and approved, confirming the lack of any contaminants.

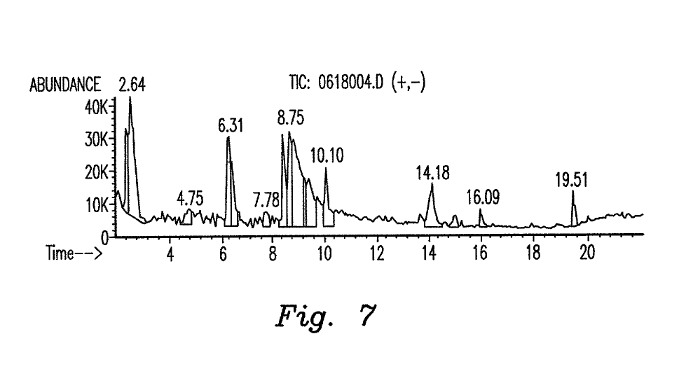

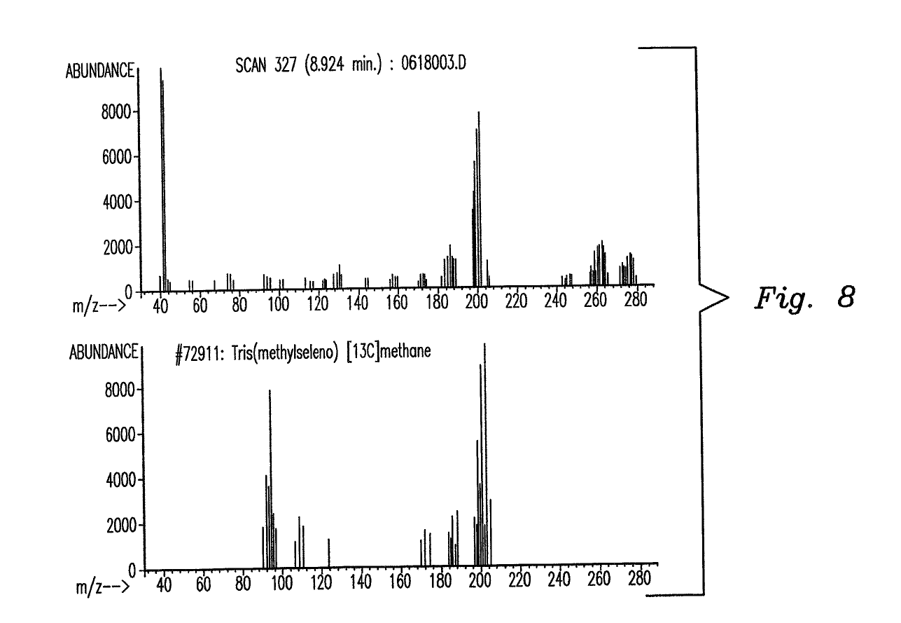

After waiting for 26 minutes, sixteen large peaks appeared on the MS screen between 40 and 500 a.m.u. as shown in FIG. 7. Each of these sixteen MS peaks resulted to be “unknown”, following a computer search of database on all known molecules available at McClellan Air Force Base, as shown in FIG. 8. No identifiable CO₂ peak was detected at all in the MS spectrum between 40 and 500 a.m.u., contrary to the known presence of such a conventional molecule in magnegas.

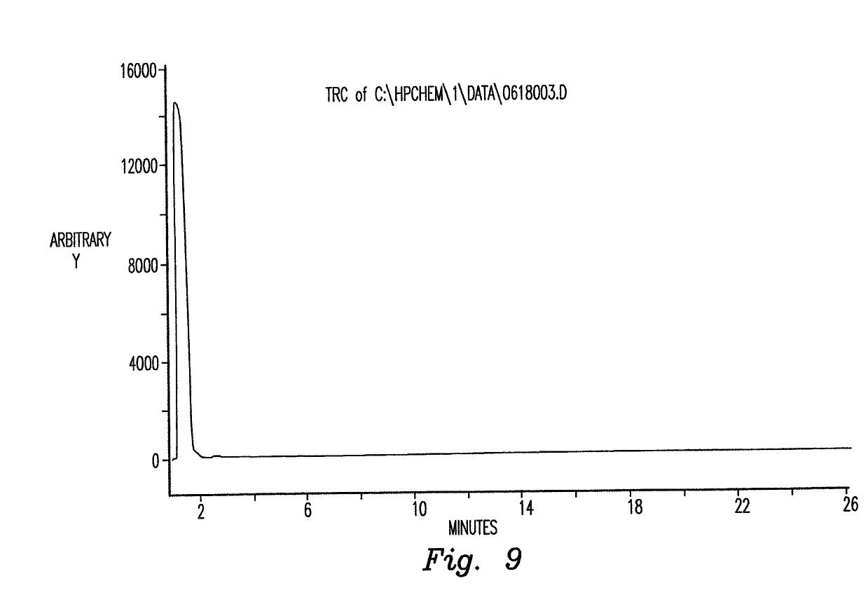

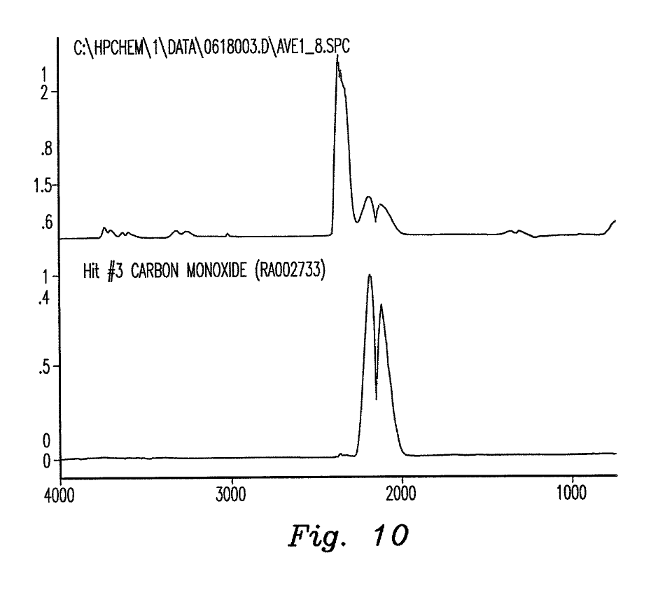

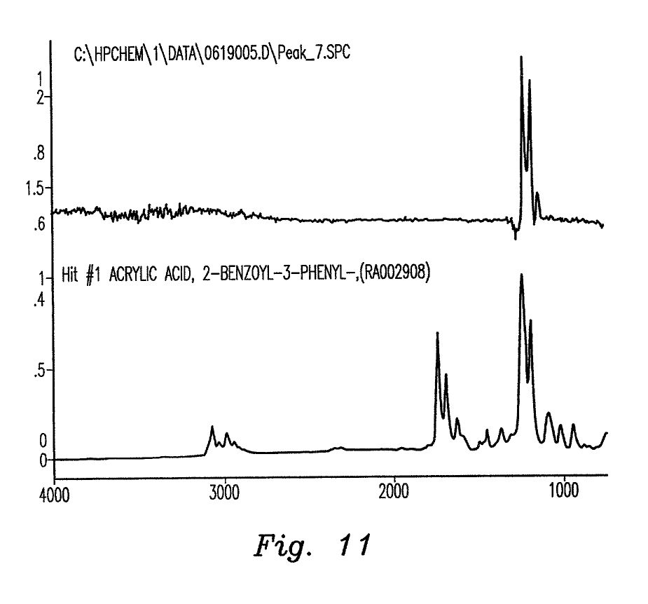

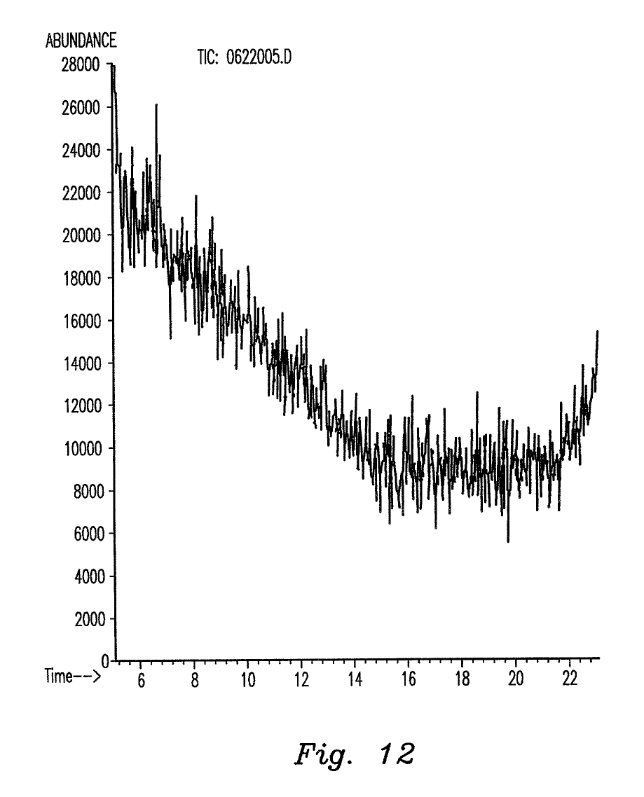

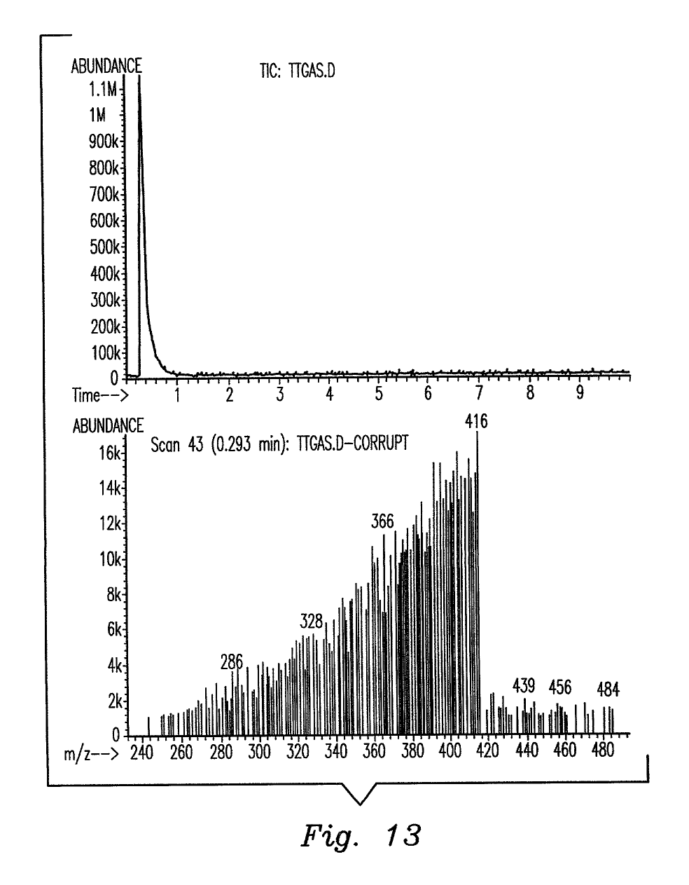

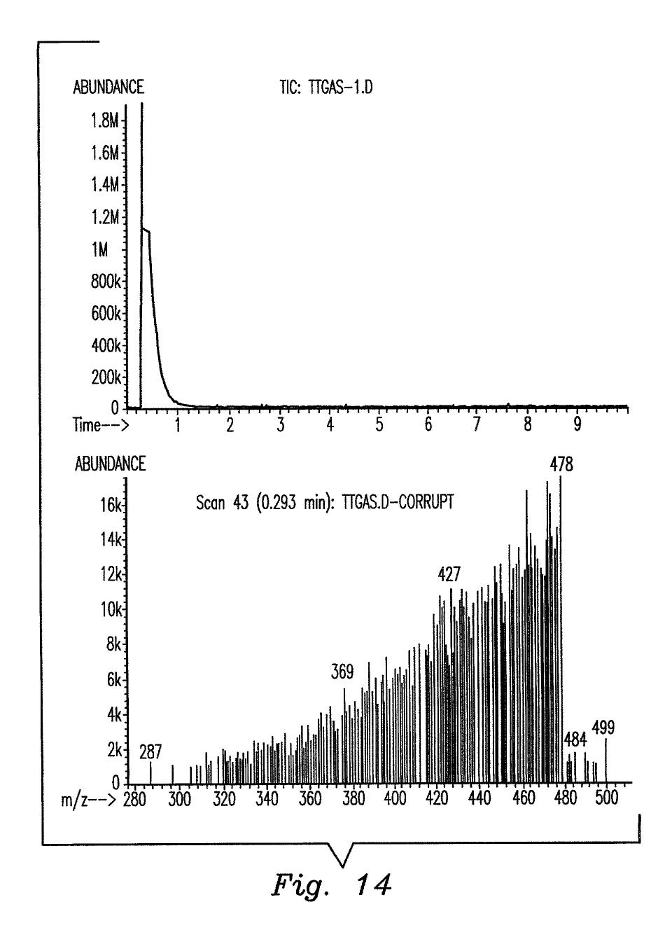

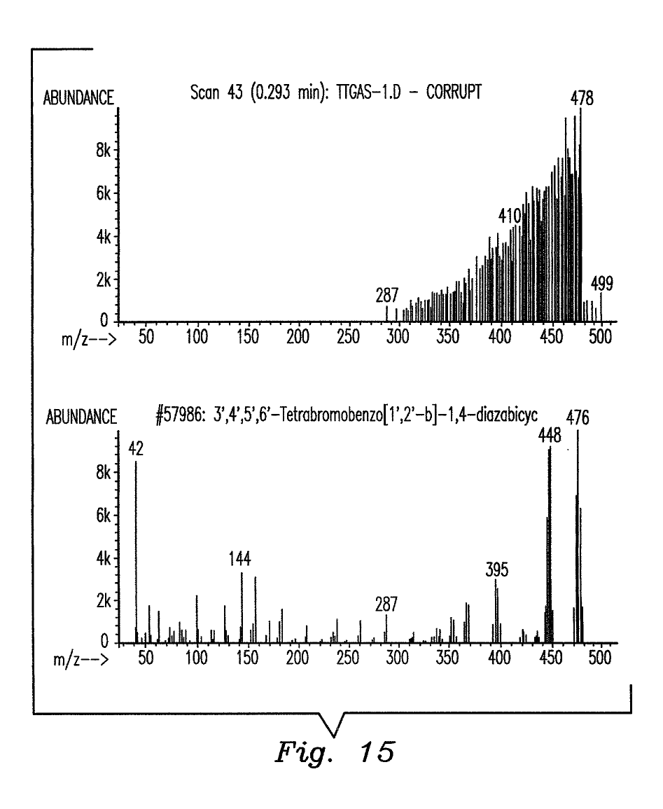

Upon the completion of the MS measurements, exactly the same range of 40 to 500 a.m.u. was subjected to IR detection. None of the sixteen peaks had any infrared signature at all, as shown in FIG. 9. Further, the IR scan for these MS peaks shows only a peak belonging to CO₂ with very small traces of other substances. Note that the IR signature of the other components, such as CO or O₂ are not detectable in this test because their atomic weights are below the left margin of the scan. In addition, the IR peak of CO₂ is itself different from that of the unpolarized molecule CO₂ as shown in FIG. 10. Note that the computer interprets the IR signature as that belonging to CO which is evidently erroneous because CO is outside of the selected range of a.m.u. units. All remaining small peaks of the IR scan also resulted to be “unknown” following a computer search in the database of IR signatures of all known molecules available at the McClellan Air Force Base, as illustrated in FIG. 11. Following the removal of magnegas from the GC-MS/IRD and conventional flushing, anomalous peaks were detected in the background similar to those of FIG. 7. Following a weekend long bakeout, the background, as shown in FIG. 12, was still anomalous, since the known correct version has a slope opposite to that of FIG. 12. The correct background was regained only after flushing the instrument with an inert gas at very high temperature.

The tests performed at McClellan Air Force Base were repeated on exactly the same sample of magnegas in the same pressure bottle at the Pinellas County Forensic Laboratory in Largo, Fla. The equipment used in the latter laboratory included an HP GC model 5890 Series II, an HP MS model 5970 and an HP IRD model 5965B attached to the GC-MS. These tests confirmed in their entirety the results previously obtained at McClellan Air Force Base, as shown in the scan of FIGS. 13, 14, 15, 16 and 17.

Magnegas was subjected to two MS tests reproduced in FIGS. 13 and 14, which occurred at about 30 minutes difference in time. As one can see, the peaks in FIG. 14 are macroscopically different from the peaks of FIG. 13 detected on the same sample just 30 minutes earlier. This difference confirmed the prediction that, when colliding, magnecules break down into fragments, which then recombine with other molecules, atoms, and/or other magnecules to form new magnecules. Similarly, the mutation of magnecules can occur via the accretion of another polarized atom, dimer, molecule, or magnecule, without breaking.

In fact, as shown by comparing the scans of FIGS. 13 and 14: the peak at 286 a.m.u. of the former becoming 287 a.m.u. in the latter, thus establishing the accretion of one hydrogen atom; the peak at 302 a.m.u. in the former becomes one at 319 a.m.u. in the latter, thus establishing the accretion of the H—O dimer; the peak at 328 a.m.u. in the former becomes 334 a.m.u. in the latter, thus establishing the accretion of one O₂ molecule; the peak at 299 a.m.u. in the former becomes 297 a.m.u. in the latter, thus exhibiting the loss of one H₂ molecule; etc. These features have been confirmed by all subsequent GC-MS/IRD scans on magnegas.

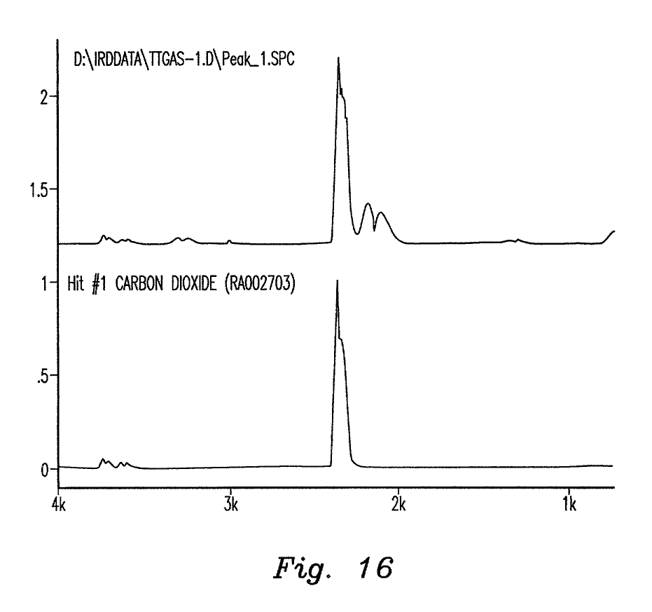

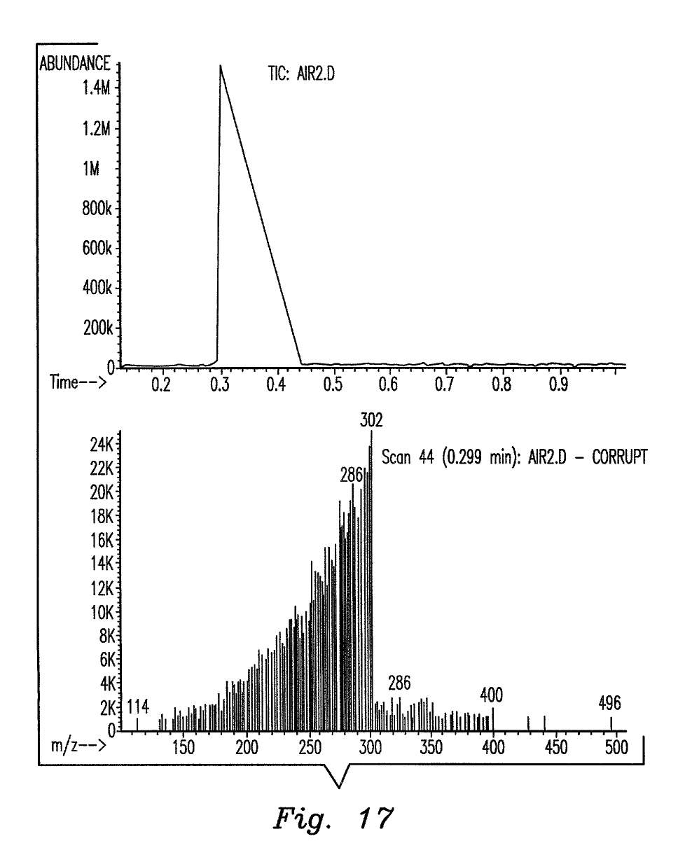

FIG. 15 depicts the complete failure by the GC-MS/IRD to identify the peaks of FIGS. 13 and 14 following a search in the database among all known molecules. FIG. 16 confirms in full the mutated IR signature of CO₂ previously identified at the McClellan Air Force Base, shown in FIG. 10, including the presence of two new peaks, with the sole difference that, this time, the computer correctly identifies the signature as that of carbon dioxide. FIG. 17 presents the background of the instrument after routine flushing with an inert gas which background, as one can see, essentially preserves the peaks of the tests, thus confirming the unique adhesion of the magnecules to the instrument walls.

A property important for the correct interpretation of the above experimental evidence is that the CO₂ peak detected in the IR scans of FIGS. 10 and 16 does not correspond to any peak in the MS of FIGS. 7, 13 and 14. More specifically, there is no MS peak in the scans of FIGS. 7, 13, and 14 identifying the CO₂ molecule. Moreover, the IR scan was done for the entire range of 40 to 500 a.m.u., thus establishing that said IR peak is the sole conventional constituent in a macroscopic percentage of all sixteen peaks in the MS, namely, the single constituent identified in the IRD is a constituent of all sixteen MS peaks of FIG. 7 or of the single large peak of FIGS. 13 and 14. It should also be noted that, as recalled earlier, the IR only detects the dimer O—C and not the complete molecule O—C—C. Therefore, the detected peak in the IR of FIGS. 9 and 16 is not sufficient to establish the presence of the complete molecule CO₂ unless the latter is independently identified in the MS. The MS scan does not identify any peak for the CO₂ molecule, as indicated above. Nevertheless, the presence in all sixteen MS peaks of FIG. 7 of complete molecules CO₂ cannot be ruled out. Therefore, the only possible conclusion is that the sixteen peaks of FIG. 7 represent clusters composed by O—C dimers and O—C—O molecules, plus other dimers, and/or other molecules, and/or atoms with atomic weight smaller than 40 a.m.u.

The large differences of MS peaks in the above two tests of exactly the same gas in exactly the same range from 40 to 500 a.m.u. although done with two different GC-MS/IRD illustrates the importance of having a ramp time of the order of 26 minutes. In fact, sixteen different peaks appeared in the MS scan following a ramp time of 26 minutes, as illustrated by FIG. 7, while all these peaks collapsed into one single peak in the MS scan of FIGS. 13 and 14, because the latter were done with a ramp time of about one minute. Therefore, the collapse of the sixteen peaks of FIG. 7 into the single large peak of FIGS. 13 and 14 is not a feature of magnecules, but rather it is due to the insufficient ramp time of the latter instrument.

The clear interpretation of the experimental evidence of FIGS. 7 to 17 is discussed below. In particular, the sixteen peaks in the MS of FIG. 7, all in macroscopic percentages, all unidentified by the computer search, none of which possesses an IR signature, establish beyond any possible doubt that the chemical composition of magnegas in the range 40 to 500 a.m.u. is totally, rather than substantially, composed by a new chemical species, namely by a pure population of clusters with new internal bonds of non-valence type. In fact, the lack of IR signature establishes that said sixteen peaks cannot possibly be molecules due to the absolute impossibility of reaching perfect spherical symmetry for such large clusters, since the perfect spherical symmetry is achievable only for very light molecules such as the hydrogen as in FIG. 2A.

Ionic clusters must also be excluded for any credible interpretation of the sixteen peaks of FIG. 7 due to the fact that ions have the same charge, and, therefore, they repel each other, rather than attract each other. Electric polarization must also be excluded from any scientific interpretation of the sixteen peaks of FIG. 7 because, as indicated earlier, such polarization is constituted by a deformation of atoms from a spherical to an ellipsoidical shape, resulting in the predominance of one electric charge at one side of the ellipsoid and the opposite polarity in the other side. The bond of opposite electric polarities of this type is extremely unstable because nuclei evidently have no physical constraints, thus re-acquiring their natural position under any minimal perturbation, such as those due to temperature, with consequential termination of the electric polarization and related electric bond. In particular, electric polarizations are excluded in a final form by the experimental evidence that the sixteen MS peaks of FIG. 7 were stable on average over a considerable period of time at ordinary temperature. Specifically, the average molecular size remains constant. The peaks did shift, however, while maintaining the average characteristics of the species.

This experimental evidence shows that the nature of the bond is not valence or electric, but rather magnetic in nature. Recall that the sixteen MS peaks of FIG. 7, or the single large peaks of FIGS. 13 and 14 indicate the existence of fully detectable clusters. Further, clusters cannot possibly exist without a well identified attractive force. Since the experimental evidence eliminates in a final and incontrovertible way the possible origin of such an attractive force as being of valence or electric type, the sole remaining possibility is that the attractive forces responsible for the sixteen peaks of FIG. 7, or the large single peaks of FIGS. 13 and 14 are of magnetic character, namely, that the indicated peaks are magnecules. Such an interpretation is first confirmed by the preservation of the peaks in the background of the equipment following the termination of the tests and its routine flushing, as in FIGS. 12 and 17. In fact, such an occurrence can only be explained by magnetic induction caused by the magnecules in the walls of the instrument, since the only other possibility, electric induction, has been excluded by other evidence and, if occurring, it would be unstable in any case.

Alternatively, the experimental evidence of FIG. 17 establishes that the clusters composing magnegas have such a large magnetic polarization that they are capable of inducing the same in the atoms of the instrument walls. The magnetic field produced by a DC electric arc with 1500 amps and 33 volts when considered at atomic or molecular distances of 10⁻⁸ cm result in a magnetic field on the order of 10¹⁶ Gauss. The magnetic origin of the bonding force is then consequential, as confirmed by numerous other evidence, such as the origination of magnegas under the extremely high magnetic field in the molecular vicinity of an electric arc, and consequential polarization of the magnetic moment of the orbits of at least the valence electrons; the polarization of the intrinsic magnetic moment of nuclei; and the polarization of the intrinsic magnetic moment of electrons when not bonded in pairs into valence couplings with antiparallel spins, as indicated earlier. Once created, these three magnetic fields are amply sufficient in intensity and stability to create a chain of magnetically polarized molecules, and/or dimers, and/or atoms, which attract each other at short distances via opposite magnetic polarities, resulting in chains such as North x South x North x South x North x South . . . . Unlike the case of bonds caused by electric polarizations, once bonded, magnetic polarizations are stable up to the Curie Temperature since rotations and other motions due to temperature occur for magnetically coupled polarities as a whole.

FIGS. 13 and 14 also establish the existence in magnecules of individual atoms. In fact, the peak at 286 a.m.u. in FIG. 13 becomes 287 a.m.u. in FIG. 14, which can only be explained by the accretion of one isolated hydrogen atom, as indicated earlier. Similar evidence, not shown, exists for the accretion of one single atom of carbon or oxygen.

Note that the very existence in magnegas of fully identifiable peaks with atomic weight of the order of several hundreds a.m.u. is direct evidence of a new chemical species. In fact, magnegas is produced from a plasma at about 10,000° C. of mostly ionized atoms of hydrogen, carbon and oxygen. When produced from distilled water via a submerged electric arc between consumable pure carbon electrodes, as it is the case for the magnegas of the tests here considered, said plasma is composed of 50% hydrogen atoms, 25% carbon atoms and 25% oxygen atoms. Consequently, in the absence of any magnetic polarization, and assuming maximal flow of the arc, the plasma should produce a gas consisting of 50% hydrogen and 50% CO with traces of O₂, H₂O and CO₂. In fact, all possible hydrocarbons must be excluded because they could not possibly survive at the 10,000° C. of the submerged electric arc, assuming that they could be formed at said temperature. In conclusion, in the absence of magnetic polarizations, the heaviest possible peak, which should exist in the magnegas of the tests here considered, should be the CO₂ molecule with 44 a.m.u. Therefore, the experimental evidence here presented of MS peaks in macroscopic percentages with several hundreds of a.m.u., as established by the measurements of FIGS. 7, 13 and 14, provide incontrovertible evidence of the new chemical species capable of constructing said heavy peaks via the use of lighter constituents.

The same presence of large peaks all the way to 500 a.m.u. establishes the increase in atomic density caused by magnetic polarization. In fact, the form of magnegas composed of 50% H₂ and 50% CO should have the average density of 15 a.m.u. while densities up to 200 a.m.u. have been measured in the laboratory for this gas.

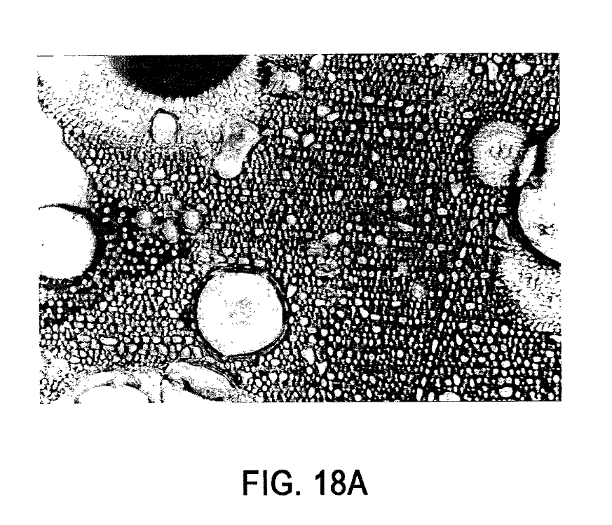

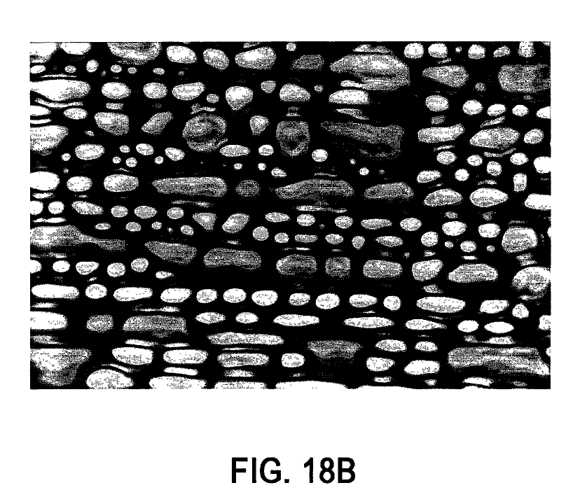

Several additional embodiments have been constructed and experiments have been conducted to create and detect magnecules in liquids. As indicated earlier, the creation of magnecules in liquids is easier than that in gases due to the dramatic reduction of rotational, vibrational and other motions in liquids as compared to those in gases. As a result, the polarization of the orbits of peripheral atomic electrons in liquids requires magnetic fields much weaker than those needed for gases. In fact, in the gas magnecules of the preceding scans were obtained with magnetic fields which, at molecular distances, are of the order of 10¹⁶ Gauss (G), while the liquid magnecules in the tests reviewed below were obtained with a magnetic field of the order of 12,000 G which is sufficient to reach measurable results. However, such a magnetic field will not produce a substantially pure population as illustrated in FIG. 18A, 18B, 19A and 19B unless it is maintained for an extended period of time on the order of about thirty (30) days. Accordingly it is clear that an essentially pure population of magnecules in liquids requires either very strong magnetic fields applied for a short period of time, or comparatively weak magnetic fields applied for a long period of time.

Even though the creation of detectable magnecules in liquid is easier than that in gases, the detection of liquid magnecules is considerably more difficult than that of gas magnecules because the virtual totality of analytic equipment available in existing laboratories is given by LC-MS without any UVD, and with small feed lines. Moreover, the available LC-MS operate at very high column temperatures, such as of the order of 250° C., which temperatures are generally greater than the Curie Temperature of the liquid magnecules themselves. As a result, the very injection of the liquid in the instrument generally destroys all entities to be detected, resulting in a generally erroneous perception of a completely conventional molecular composition without real scientific evidence.

In fact, for magnetically polarized liquids, conventional molecular interpretations are in dramatic disagreement with a number of other experimental data, thus having no scientific credibility. As a specific illustration, the creation of the new chemical species of magnecules in oils implies: 1) a dramatic transition from complete transparency to its complete absence; 2) a dramatic increase in specific density; 3) a dramatic change in adhesion, chemical reactions, surface tension, and other features. It is evident that any attempt to represent such dramatic changes via the conventional species of molecules has no scientific credibility, while all the same changes are readily represented in a quantitative form by the new species of magnecules.

Ironically, currently used feeling lines, syringes and methods do not even permit the injection of liquid magnecules in the LC-MS, let alone their detection. This is because, unlike the case of gases, liquid magnecules can be so large as to be visible to the naked eye, thus being much larger than the sectional area of feeding lines currently used for conventional liquids. Even when feeding lines have the same dimension as those of liquid magnecules, the latter cannot freely propagate in them due to their anomalous adhesion which, in certain cases required the use of strong acids for their removal. Under these unfavorable conditions, one can at best expect that only small fragments of magnecules can enter conventional LC-MS, and positively no claim of measurements can be ventured for magnecules visible to the naked eye with dimensions greater than the feeding lines, syringes and other injection instruments.

The above occurrences confirm the general inability of currently available LC-MS to detect liquid magnecules, and the need stressed earlier of new equipment and procedures specifically conceived to detect the new chemical species of magnecules. In fact, liquid magnecules are fully identified via the use of the appropriate LC-MS instrument equipped with the UVD, and verifying the other requirements indicated earlier, such as column temperature below the Curie Temperature of the magnecule to be detected, use of very large feeding lines, ramp times of the order of 25 minutes or more, etc.

The experimental evidence establishing the existence of liquid magnecules and their unique properties is summarized below. A number of samples of fragrance oils were obtained from a distributor of such oils. The samples were all perfectly transparent and each had a known viscosity. Fifty cc of each of these oils were placed in individual glass containers. Several alnico permanent magnets with 12,000 G and dimension ½″ by 1″ by 2″ were used. A polarity of said permanent magnets was then immersed in the jars filled with said fragrance oils, while the other polarity was outside the liquid.

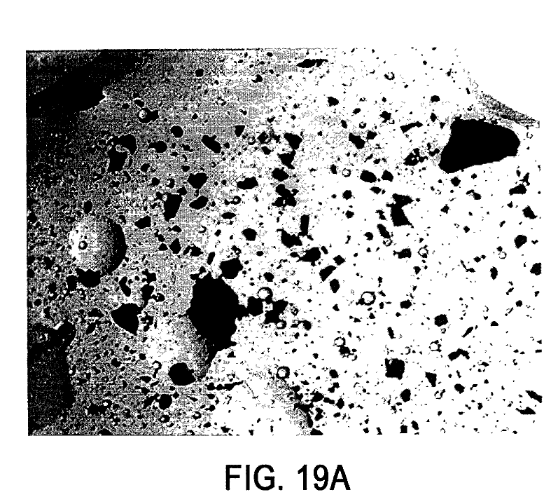

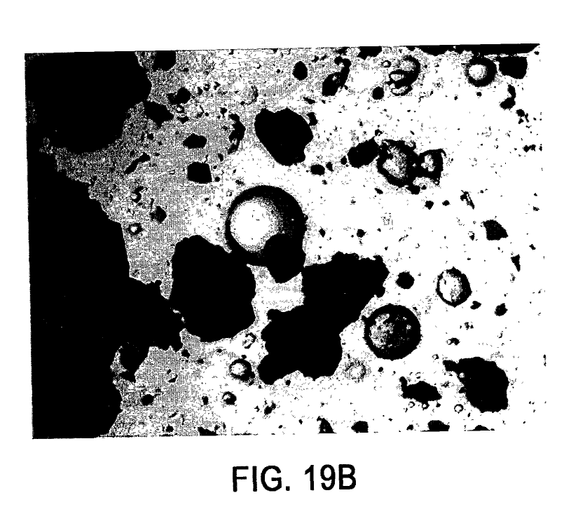

After two days, a visible darkening and increase in viscosity of the oils occurred which varied from oil to oil. Both the darkening and the viscosity increased progressively in subsequent days, to reach in certain cases a dark brown color completely opaque to light and the loss of fluidity. In certain samples, the complete loss of transparency was reached following intermediate stages with completely opaque granules initially visible with a microscope and then visible to the naked eyes, as established by FIGS. 18 and 19, until the granular structure was lost in favor of a completely homogeneous opaque liquid.

These visible effects can only be of magnetic origin because the fragrance oils were subjected to no outside action other than the application of the indicated magnetic fields. In particular, the permanent magnets were sterilized prior to their immersion in the oils and the samples were maintained undisturbed at room temperature. The explanation of these visible changes, subsequently confirmed by LC-MS/UVD tests reviewed later, is given by the polarization of the orbits of at least some of the peripheral electrons of the atoms constituting the liquid molecules and the ensuing formation of magnecular chains North-South-North-South-North-South-etc. of increasing dimension all the way to be visible to the naked eye.

Particularly important for the above magnetic polarization is the presence in the liquid considered of dimers such as H—O, H—C, etc., which essentially acquire the same magnetic polarization as that for gases according to FIGS. 1 to 5. Liquid magnecules can then occur via the sole magnetic bond of dimers without any need for the magnetic bonding of complete molecules.

Consider, for instance, two liquids, which are not soluble in each other, such as water and oil, which both have the H—O dimers. Under the exposure of a conventional mixture of said two liquids to a magnetic field, individual dimers H—O may acquire a magnetic polarization, resulting in the planar configuration of FIG. 5A. It then follows that one molecule of water can indeed bond to one molecule of oil via the magnetic bond of their respective H—O dimers, while the remaining parts of the two molecules remain in their conventional state. By keeping in mind that oil molecules may have a large number of H—O dimers, then another dimer of the preceding oil molecule can bond magnetically to an H—O dimer of another water molecule, or the second H—O dimer of the first water molecule can bond to an H—O dimer of another oil molecule, resulting in this way in a chain of partially bonded liquid molecules. The net result is the creation of a completely new liquid between two liquids, which are not soluble in each other, which new liquid is not a solution or a suspension or any other prior art configuration, but it is constituted of the new chemical species of liquid magnecules.

The alteration of the structure of fragrance oils was confirmed by two photographs under the microscope taken in two different laboratories, as it is the case for all experimental evidence presented herein. FIGS. 18A was taken at a magnification of 10×, and FIG. 18B was taken at a magnification of 100×. Both FIGS. 18A and 18B refer to the fragrance oil identified under the code “ING258IN, Text 2” and subjected to the magnetic polarization described above. As one can see, FIG. 18A establishes that, under the indicated magnetic treatment, the oil has acquired a kind of “brick layering structure” which is visible under only 10×magnification. The same “brick layering structure” is confirmed by FIG. 18B under magnification 100×.

Note that the magnecules are not constituted by the individual “bricks,” but rather by the opaque substance which interlocks said “bricks,” since the latter preserves the original transparency. Inspection of the photographs shows a variety of sizes of magnecules, thus establishing their lack of unique atomic weight for any given oil. If valence bonds were involved a fixed maximal size would be shown. The photographs also show the accretion capability of magnecules, that is, their capability of increasing their size via the addition of other magnetically polarized molecules.

Since fragrance oils are generally composed by different conventional molecules, the opaque liquid in between the “bricks” of FIGS. 18A and 18B is constituted by a lattice of generally different oil molecules which are interlocked via the strong attractive force between opposite polarities of magnetically polarized H—O and other dimers as in FIG. 5A, such as (. . . H—O)x(H—O— . . . ). The complete lack of transparency is then consequential because light does not possess a frequency or, equivalently, an energy suitable to break said bonded dimers due to the very small inter-dimer distance.

The photographs of FIGS. 19A and 19B were taken at the Marine Science Laboratory of the University of South Florida in St. Petersburg. FIGS. 19A and 19B also refer to magnifications 10× and 100×, respectively, although for a different fragrance oil identified under the code name of “Mixture 2”, which oil was subjected to the same magnetic polarization indicated above. Despite the different chemical structure of the latter oil, the results were essentially the same as those of the preceding oil, namely, there was the formation in a few days of very small granules only visible with the microscope, and their progressive accretion into opaque granules visible to the naked eye suspended in a transparent medium, until the achievement of a homogeneous and opaque liquid with high viscosity.

As shown in FIG. 19A, following two days of exposure to a 12,000 G magnetic field, the molecules of said fragrance oil bonded together into rather large clusters with an atomic weight estimated to be well in excess of 10,000 a.m.u. The visible structural differences in FIGS. 18A-18B and 19A-19B indicate that the magnetic polarization of liquids is not the same for all liquids, but varies with their composition, depending on the geometry of each molecule, the nature and location of their dimers and other aspects.

The existence of magnecules in liquids also results in alterations, called “mutations”, of physical characteristics, such as increases in specific density and viscosity. It is evident that magnetic bonds in ordinary molecules imply an evident reduction of intermolecular distances, with a consequential increase in the number of ordinary molecules per unit volume. The consequential increase in specific weight then implies an increase in viscosity. These physical changes are large macroscopic alterations, which are often visible to the naked eye.

Various measurements of specific density and viscosity were conducted at the analytic laboratory U.S. Testing Company, Inc. of Fairfield, N.J. The measurements were conducted on ordinary tap water, fragrance oils and engine oils subjected to the indicated magnetic polarization. Samples were prepared by mixing conventional tap water and one fragrant oil, and then subjecting the mixture to the rather weak field of a permanent magnet with 200 G. After treatment for about two days, all samples were stable without any measurable changes detected over a period of about one full year. Further, the samples remained unchanged upon freezing and subsequent thawing.

Ordinary untreated tap water was denoted Sample 1; Sample 2 was ordinary tap water magnetically treated for about 5 minutes; Samples 3 and 4 were ordinary tap water magnetically treated with equipment different than that used to treat Sample 2; Fragrance 5 was an untreated fragrance oil identified under the code name “APC Fragrance”; Mixture 6 was fragrance oil “APC Fragrance” mixed 50-50 with tap water and thereafter magnetically treated for about 5 minutes; Mixtures 7 and 8 were the same Mixture 6 except that they were magnetically treated with equipment different than that used to treat Mixture 6. Fragrance 17 was a magnetically treated oil identified under the code name “Air Freshener 1”; Mixture 19 was Fragrance 17 mixed with Treated Water 16 and magnetically treated for 5 minutes. All measurements were performed to an accuracy of the fourth digit. Accordingly, the numerical results of the first two digits are accurate.

As expected, in the transition from Sample 1 (untreated water) to Sample 2 (magnetically treated water) there was an increase in the specific density in the macroscopic amount of 0.86%. As is well known, fragrance oils are generally lighter than water, i.e., the specific density of the untreated Fragrance 5 is less than that of untreated water in Sample 1. However, the specific density of the magnetically treated mixture of “APC fragrance 1” with tap water, Sample 6, resulted in a specific density 0.49% greater than that of water, while, for a conventional molecular structure, the specific weight of said mixture should have been in between the specific weight of water and that of the oil. Similarly, Mixture 6 was 1.86% heavier than the untreated tap water it contained; Mixture 7 was 1.60% heavier than untreated tap water; Mixture 8 was 0.99% heavier than untreated tap water; Sample 16 was 0.89% heavier than untreated tap water; Mixture 18 was 0.99% heavier than untreated tap water; and Mixture 19 was 1.26% heavier than untreated tap water.

The viscosity of magnetically treated liquids was also measured at the analytic laboratory U.S. Testing Company, Inc. of Fairfield, N.J., and was dramatically greater than the viscosity of untreated liquid, thus confirming in full the visual observations indicated earlier. Ordinary engine oils are particularly suited for magnetic polarization because their increase in viscosity with a corresponding change in the visual appearance of color, texture, opacity, etc. The engine oil selected for the viscosity measurements was a sample of ordinarily available 30-40 Castrol Motor Oil, which was subjected to two different types of magnetic polarizations called of Type A and B, and referred to increasing occlusion of atmospheric gases. All treatments were done at ordinary conditions of atmospheric temperature and pressure without any chemical additives. Measurements conducted at the indicated analytic laboratory established a dramatic 44.5% increase in the viscosity in the oil with magnetic treatment A, exposure of the liquid to North polarity, as compared to the viscosity of the untreated oil, while measurements on the oil with magnetic treatment B, exposure of the liquid to South polarity, established the dramatic increase of 51.2% in viscosity.

The above indicated measurements also established other unique chemical properties of liquid magnecules. The most visible one was the malfunctioning of all equipment following their exposure to magnetically polarized liquids and their standard cleaning used for all conventional liquids. Following contact with liquid magnecules, the instruments were cleaned with very strong acids at high temperature, after which conventional working conditions were regained. The malfunction was evidently caused by the unique adhesion of magnecules, which, for the case of liquids is so dramatic as to require high temperatures for their removal.

The above tests also confirmed the unique thermochemical behavior of liquid magnecules. In fact, the action of acids on magnetically treated liquids was dramatically different both in energy release as well as color and appearance as compared to the action of the same acid on a magnetically unpolarized liquid.

Finally, the above tests also established the unique penetration characteristics of magnetically polarized liquid through other substances.

Other examples of an essentially pure population of magnecules in liquid have been obtained at U.S. Magnegas, Inc., Largo, Fla., with the PlasmaArcFlow Reactor as described above with a DC electric arc of 1000 amps and 30 volts. Three different examples of essentially pure populations of magnecules were obtained. The first species was obtained by flowing antifreeze through the electric arc for approximately two (2) hours. The second species was obtained by flowing engine oil through the electric arc for approximately two (2) hours. The third species was obtained by mixing equal volumes of the above two species, which do not normally mix, yet these substances mixed after the treatment indicated above and bonded in such a fashion to be so dense as to be non-pumpable.

As indicated earlier, magnecules are also present in solids. In particular, all liquids with a magnecular structure preserve the new species when frozen and then liquefied again. In fact, all unique characteristics were recovered in the return to the liquid state, thus confirming the preservation of magnecules in the transition from liquid to solid state, as readily expected, since such a transition implies a decrease of Brownian and other motions with a consequential increase in stability of the magnecules. Therefore, the experimental evidence on the existence of magnecules in gases and liquids is direct experimental evidence of the existence of magnecules in solids, since the latter can be merely obtained by freezing the former.

The first mass spectrographic experimental evidence on magnecules in liquids was established at the Tekmar-Dohrmann Corporation (TDC) in Cincinnati, Ohio, by operating a Tekmar 7000 HT Static Headspacer Autosampler equipped with a Flame Ionization Detector (FID). The measurements were done on: Sample 1, pure magnetically untreated “Fragrance Oil”; Sample 2, magnetically treated tap water; and Sample 3, a magnetically treated mixture of the preceding two liquids.

Recall that magnecules in liquids can have very large atomic weights all the way to 10,000 a.m.u. and more, thus requiring instruments equipped with very large feeding lines, and capable of scanning all the way to very high weights. These and other features were absent in the indicated Tekmar instrument. Despite that, the TDC tests constitute direct mass spectroscopic experimental evidence of the existence of magnecules in liquids, including direct experimental evidence of water magnecules.

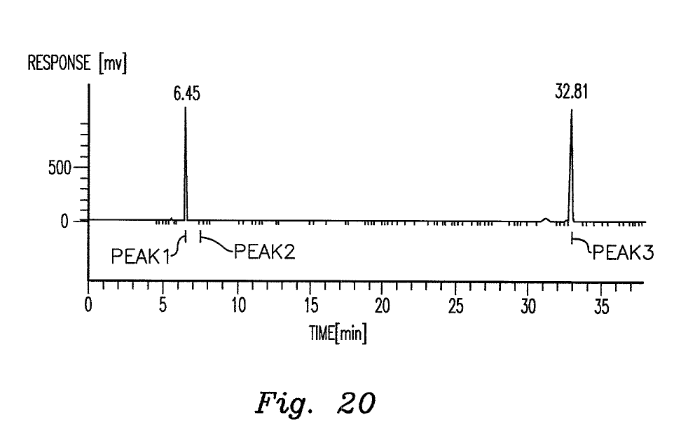

FIG. 20 reproduces the TDC scan of magnetically untreated fragrance oil “Mixture 2”. The default report of the scan, not shown, shows the oil to be composed of the following three primary molecules characterized by: Peak 1 at 6.448 min and 22.96%; Peak 2 at 7.378 min and 0.02%; and Peak 3 at 32.808 min and 68%. It should be noted that this is the chemical structure of the fragrance oil of FIGS. 19A-19B.

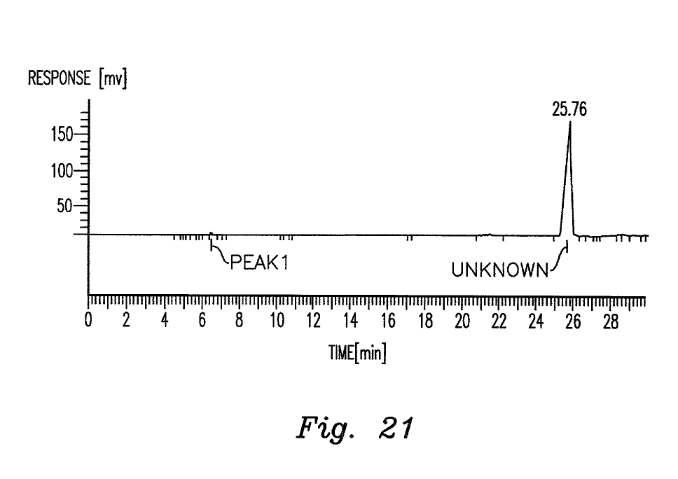

FIG. 21 shows spectroscopic experimental evidence of magnecules in magnetically treated tap water and characterized by the large unknown peak at 25.763 min whose default report, not shown, and 64.24%. According to the terminology introduced earlier, this unknown peak represents a magneplex, namely, a magnecule solely composed of magnetically polarized molecules of the same type, in this case that of water. In fact, the field of the 12,000 G used for the magnetic polarization of water cannot possibly break down the water molecule. Therefore, the magnecule here referred to is solely composed of molecule without any appreciable percentage of dimers and/or of isolated atoms. Finally, the magnetic polarization was done on water, thus implying that the constituents of the magnecule here considered are the same, thus resulting in a magneplex.

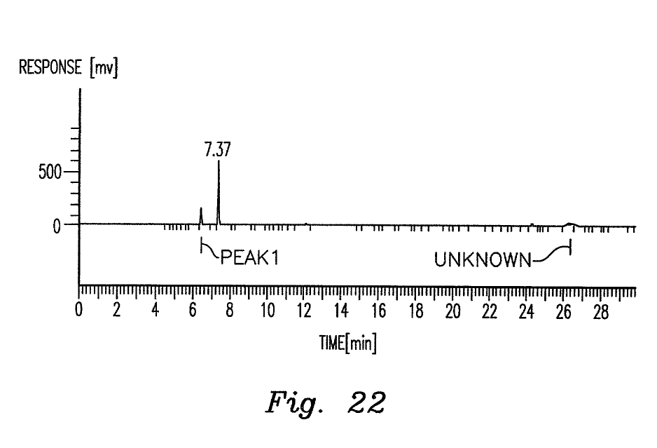

FIG. 22 reproduces experimental evidence of magnecules in a magnetically treated 50-50 mixture of tap water and fragrance oil “Mixture 2”. The primary stable clusters detected by the instruments according to the default report, not shown, are: a first peak at 6.449 min for 5.33%; a second peak at 7.373 min for 18.74%; a third peak listed by the equipment as unknown 1 at 26.272 min for 1.75%; a fourth peak at 26.347 for 1.16%; a fifth peak listed by the equipment as unknown 2 at 31.491 for 0.45%; and a sixth peak at 32.758 min for 68.71%. Comparison of the above scan with the separate scans of tap water and the fragrance oil “Mixture 2” establishes beyond any possible doubt the creation of liquid magnecules by the magnetic polarization of their mixture. Since the intensity of the magnetic field here used was absolutely insufficient to break down the molecules of water and of the fragrance oil, the only possible constituents of the new peaks are conventional molecules. Therefore, the new clusters characterized by the unknown peaks of this scan are given by water molecules plus oil molecules 1, 2 and 3 of FIG. 20.

Note also that in FIG. 20 the percentage of Peak 1 is 148 times greater than that of Peak 2. In the transition to the magnetically polarized case, Peak 2 becomes dominant over Peak 1, the percentage of the former being 3.51 times that of the latter. This is evidence of the capability of the molecule represented by Peak 1 to acquire more magnetic polarizations than that of Peak 2. This is a rather general occurrence because, as indicated earlier, the magnetic polarization of the orbits of peripheral atomic electrons depends on the space geometry of the molecule considered, its dimers H—O or H—C and various other features.

Numerous additional tests were conducted at the TDC laboratory, not reported here for brevity. These tests confirmed all other features of liquid magnecules, such as their mutation, i.e., the variation in time of their atomic weight or percentage, and their unique adhesion. In fact, all blanks of the Tekmar instrument following measurements of liquid magnecules were dramatically different than the blanks prior to the injection of magnetically polarized liquids. Moreover, the peaks of the blanks were essentially those of the magnecules, rather than of conventional molecules. As indicated earlier, this occurrence is due to the induction of a magnetic polarization by magnecules on the instrument walls, resulting in a consequential unique adhesion. As a matter of fact, one way to confirm the detection of a magnecule during a test is by verifying that such a magnecule does indeed persist in the blank following the completion of the test, a procedure which is important for this invention but completely senseless for the conventional chemical species of molecules. In any case, as it was the case for gas magnecules, conventional blanks are readily obtained by flushing the instrument with a suitable inert substance at high temperature.

Comprehensive tests via a very modern LC-MS equipped with UVD were conducted on magnetically treated liquids at the Department of Chemistry of Florida International University in Miami (FIU). These tests were conducted under a number of technical characterizations specifically selected to detect magnecules, such as:

1) Total Ion Chromatogram (TIC), which was operated under the positive ion atmospheric pressure electrospray ionization (ESI+) mode;

2) Integrated TIC with retention times and areas for the most abundant peaks;

3) Raw mass spectra for all peaks identified in item 2;

4) HPLC chromatograms collected at fixed wavelength of 254 cm;

5) UV-visible spectra form the HPLC diode array detector from 230 to 700 mm.

The FIU tests were conducted on the following samples:

A) The magnetically untreated, fully transparent fragrance oil “ING258IN Test 2”;

B) The magnetically treated “ING258IN Test 2” with 10% DiproPylene Glycol (DPG);

C) The bottom layer of the preceding sample;

D) The magnetically treated mixture 4% fragrance oil “ING258IN Test 2”, 0.4% DPG and 95% tap water; and

B) The visible dark clusters in the preceding sample as seen under the microscope and reproduced in FIGS. 18A-18B.

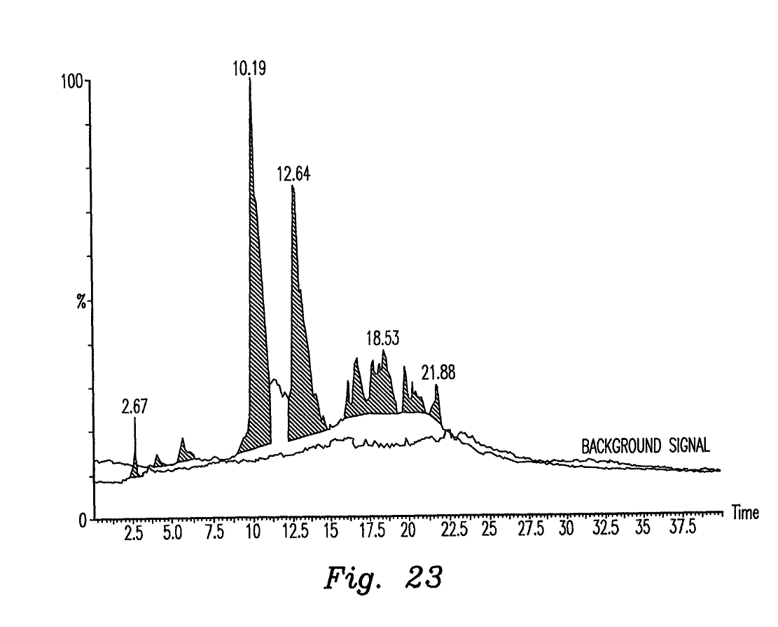

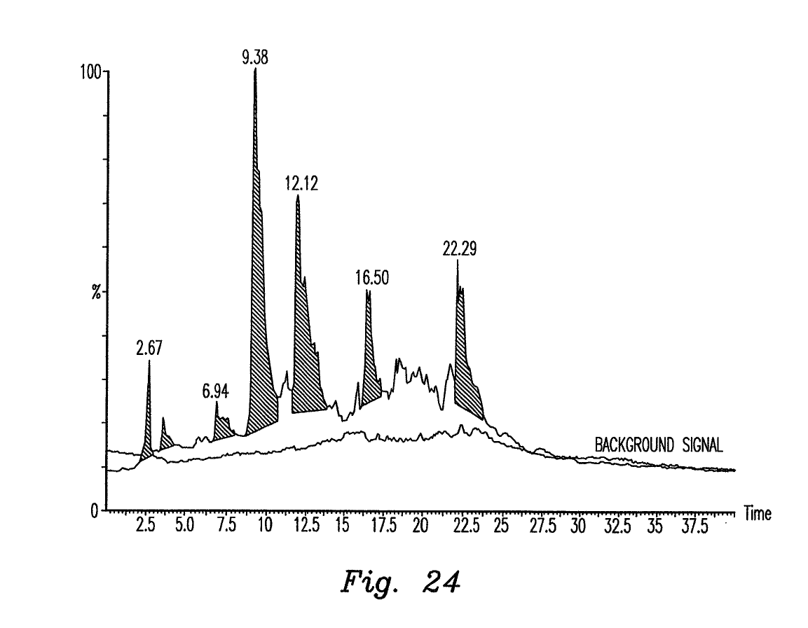

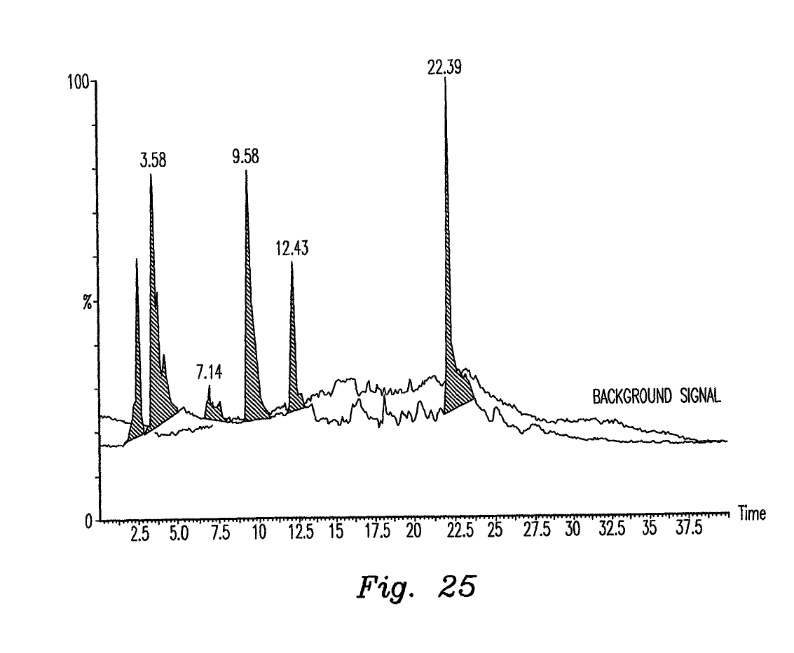

To avoid a prohibitive length of these specifications, only representative scans of the FIU tests are reproduced below. In particular, FIG. 23 reproduces the scan of the magnetically unpolarized fragrance oil “ING258IN Test 2” of FIGS. 18A-18B. FIG. 24 reproduces the scan of the magnetically polarized oil “ING258IN Test 2” with 10% DPG. FIG. 25 reproduces the scan of the dark liquid at the bottom of the sample tested with the scan of FIG. 24. A large variety of additional scans are omitted for brevity.

Inspection of the scans of FIGS. 23-25, as well as, of the numerous others obtained at FIU establishes beyond any possible doubt the existence of magnecules in liquids characterized by various unknown MS peaks, none of which has any UV signature other than that of the molecular constituents, one of which is represented by the large unknown peak in FIGS. 24 and 25. Note a corresponding decrease of the peaks representing conventional molecules as compared to the value of FIG. 23. The latter occurrence is necessary for the correct detection of magnecules because molecules are removed in their conventionally detected state when turned as constituents of magnecules. The same FIU tests confirmed all other features of liquid magnecules, such as their mutation, unique adhesion and unique penetration.

It should be noted that the magnetically polarized liquids of the above TDC and FIU tests do not constitute an essentially pure population of the new chemical species of magnecules, as it is the case of the scan of FIG. 7 for gases. This is due to the presence in macroscopic percentages of conventional molecules, which must be evidently absent to have an essentially pure population of magnecules. This occurrence was also expected and it is due to the insufficient value 12,000 G of the magnetic field used in the polarization of the liquids. In fact, additional tests, not reported here for brevity, conducted by exposing the same mixture of tap water and fragrance oils to extremely strong magnetic fields, on the order of 1016 Gauss at molecular distances, have proved the complete disappearance of any identifiable molecule and the sole composition of the mixture as being that of an essentially pure population of magnecules, exactly as it is the case for gases exposed to magnetic fields of similar intensity. The essentially pure population of liquid magnecules is generally obtained by exposing the liquids to electric discharges which can, this time, break down conventional liquid molecules into their dimers and individual atoms. As a result, for the case of an essentially pure population, liquid magnecules are generally constituted by molecules, dimers and individual atoms, as it was the case for gases and in accordance with the definition of magnecules.

Gaseous, liquid or solid magnecules have truly novel and important, industrial, commercial, and consumer applications in a variety of fields, including, but not limiting to, fuel industry, fragrance industry, paint industry, adhesive industry, medical industry, etc., among which we note:

1) Regarding the fuel industry, truly new fuels composed of an essentially pure population of magnecules are now industrially feasible to produce on a mass scale. The new fuels possess dramatic increases of energy content; surpass all EPA requirements without a catalytic converter; emit during combustion no carcinogenic, carbon monoxide or other toxic substances; reduce the emission of carbon dioxide in gasoline combustion by about 50%; emit in the exhaust up to 14% breathable oxygen; are dramatically safer than gasoline; and are cost competitive with respect to the latter. In particular, the new fuels with magnecular structure are produced from the processing of liquid waste by the PlasmaArcFlow reactors of FIGS. 26 and 27, although the best possible liquid is crude oil. Rather than turning crude oil into the polluting and expensive gasoline, this invention permits the processing of crude oil into a new fuel with magnecular structure, which is dramatically cleaner, cheaper and safer than gasoline. In view of all these features, it is a truism to state that the new chemical species of this invention can produce a revolution in electric power generation, the fuel and automotive industries to the benefit of the environment and the consumer. Moreover, the carbon-free version of magnegas, called maghydrogen because it is constituted by hydrogen with a magnecular structure, is dramatically better than conventional hydrogen because its larger atomic density, the avoidance of liquefaction for use as a fuel for internal combustion engines, and provides a longer duration and larger energy output. Finally, the use in fuel cells of maghydrogen provides a quantum increase in efficiency, and, when burning with a magnetically polarized oxygen called magoxygen, it provides an ever greater increase in efficiency and duration, with evident benefits for the industry, the consumer and the environment.

2) Regarding the fragrance industry, magnecules permit the industrial production and consumer use of basically new perfumes, which are water based, rather than currently available perfumes, which are alcohol, based. The former perfumes have dramatic advantages over the latter, such as: alcohol ages the human skin, while water does not; water based perfumes evaporate much slower than their alcohol based counterpart, thus lasting longer; perfumes with a magnecular structure penetrates the human skin much deeper than the alcohol based perfumes, thus providing a longer lasting and individualized fragrance. In particular, water based perfumes can be used for the first time by those whose religion prohibits the use of alcohol based perfumes.

3) Regarding the paint industry, magnecules permit the industrial production and commercial or consumer usage of basically new paints, which adhere to walls dramatically, more than conventional paints due to the unique adhesion of magnecules.

4) Regarding the adhesive industry, magnecules permit the industrial production and use of basically a new adhesive with adhesion dramatically greater than that of currently available adhesives, again due to the unique adhesion of magnecules. In particular, different adhesives are currently needed for different substances, such as wood, ceramics, metals, etc. Due to the universality of their unique adhesion, magnecules permit the elimination of these differences and the use of only one adhesive for all possible substances.

5) Regarding the medical industry, magnecules permit numerous new applications. For instance, this invention permits new methods for delivering drugs consisting of their penetration through the skin, by therefore eliminating in appropriate cases the delivery of drugs via injection. This new method is permitted by the unique penetration of magnecules through other substances due to a combination of factors, such as the reduction of the average size which is inherent in the magnetic polarization combined with magnetic induction, according to which magnecules can literally propagate from one to the other molecule of a given substance. The advantage of this new method of drug delivery is evident, for instance, in the case of infected wounds where the use of conventional drugs remains in the surface of the human body, thus requiring injection of the drug and its propagation throughout the entire human body, at times with well known side effects, just to reach an infection localized in one small part of the body. By comparison, drugs with magnecular structure can easily penetrate throughout the entire infected area and below, precisely in view of the indicated magnetic induction and related unique penetration. Basically new drugs are also permitted by the unique features of magnecules, such as their unique release of heat, which can be used for new lotions usable in massages, or other treatments. Yet another medical application is the capability to preserve indefinitely the sterilization of surgical instruments when immersed within magnetically polarized water, as compared to the current exposure of said surgical instruments to air, and the consequential loss of their sterile character prior to their use in surgeries. In fact, magnetically polarized water is easily completely sterilized and remains so on an indefinite basis, since it does not permit the reproduction of bacteria or other living organisms due to its structural difference from the water molecules needed for such reproduction.

It should however be stressed that each and every one of the above novel industrial, commercial or consumer applications crucially depends on the technological capability to reach an essentially pure population of magnecules because none of the indicated new applications is meaningful when only traces of magnecules occur in substances with conventional molecular structures.

The invention is clearly new and useful. Moreover, it was not obvious to those of ordinary skill in this art at the time it was made, in view of the prior art considered as a whole as required by law.

It will thus be seen that the unique properties and benefits set forth above, and those made apparent from the foregoing description, are efficiently attained. It is intended that all matters contained in the foregoing description or shown in the accompanying drawings shall be interpreted as illustrative and not in the limiting sense.

It is also to be understood that the following claims are intended to cover all of the generic and specific features of the invention herein described, and all statements of the scope of the invention which, as a matter of language, might be said to fall therebetween.

Now that the invention has been described,

What is claimed is:

1. A chemical composition comprising:
a substantially pure population of magnecules composed of clusters of one of a molecule, a dimer, an atom and combinations thereof in combination with one of another molecule, dimer or atom, and any combination thereof said magnecules being detectable via peaks in mass spectrometry;
said peaks in the mass spectrometry being unidentifiable as any known conventional molecule and said magnecules having no infrared signature for a gas or ultraviolet signature for a liquid or other signature for a solid other than a corresponding signature of conventional molecules or dimers constituting said magnecules; and
said magnecules being formed by mutual attractions among opposite polarities of a magnetic polarization of orbits of at least some peripheral electrons of atomic constituents of said magnecules in conjunction with a polarization of intrinsic magnetic moments of nuclei and a polarization of intrinsic magnetic moments of electrons, when a pair of said polarization of intrinsic magnetic moments of electrons is not correlated into antiparallel valence bonds.

2. The chemical compositions of claim 1, wherein said magnetic polarizations of said orbits of peripheral electrons and said intrinsic magnetic moments are formed by subjecting a substance to any one of an external magnetic field, external electromagnetic field, microwave, pressure, friction, and any combination thereof.

3. The chemical compositions of claim 1, wherein said infrared signatures for gases or ultraviolet signatures for liquids or other signatures for solids due to conventional molecules and dimers constituting the magnecules are altered because of the presence of peaks not existing in conventional signatures.

4. The chemical compositions of claim 3, wherein said peaks not existing in conventional signatures originate from attractive forces between opposite inter-atomic polarities of a magnetic polarization of the orbits of at least some of the peripheral non-valence electrons of the atoms constituting said conventional molecule or dimer in conjunction with the polarization of the intrinsic magnetic moments of nuclei and of electrons, when not correlated into valence bonds with antiparallel spins.

5. The chemical compositions of claim 1, wherein the average density is greater than that of the conventional molecules constituting said magnecules and any of their combination under the same conditions of volume, pressure and temperature.

6. The chemical compositions of claim 1, wherein an excess energy content is released from a thermochemical reaction of said essentially pure population of magnecules as compared to the energy released by thermochemical reaction of any conventional molecular constituent and any combinations thereof.

7. The chemical compositions of claim 6, wherein the excess energy content is due to a storage of energy in the structure of said magnecules, said conventional molecules and said dimers constituting the magnecules.

8. The chemical compositions of claim 1, wherein said peaks in the mass spectrometry change in time while keeping constant the average magnecular density.

9. The chemical compositions of claim 1, wherein said essentially pure population of magnecules has an excess adhesion to other substances when compared to the adhesion of any molecule constituting said magnecules and any combinations thereof.

10. The chemical compositions of claim 9, wherein said excess adhesion originates from a magnetic polarization via induction of the orbit and intrinsic magnetic moments of atoms constituting said other substances to provide a bond between said magnecules and said other substances among opposite of said magnetic polarizations.

11. The chemical compositions of claim 1, wherein said essentially pure population of magnecules has an excess penetration within other substances as compared to that of any conventional molecule constituting said magnecules or that of any of combinations thereof.

12. The chemical compositions of claim 11, wherein said excess penetration originates from a reduction of an average size of conventional molecules constituting said magnecules due to magnetic polarization of the orbits of at least one of the peripheral electrons of the atoms constituting said magnecule.

13. The chemical compositions of claim 2, wherein said essentially pure population of magnecules is formed from a substance having a single molecule.

14. The chemical compositions of claim 2, wherein said essentially pure population of magnecules is formed from a substance having at least two different molecules.

15. The chemical compositions of claim 1, wherein said essentially pure population of magnecules is a gas.

16. The chemical compositions of claim 1, wherein said essentially pure population of magnecules is a liquid.

17. The chemical compositions of claim 1, wherein said essentially pure population of magnecules is a solid.

18. The chemical compositions of claim 1, wherein said essentially pure population of magnecules is a combustible fuel.

19. The chemical compositions of claim 18, wherein said combustible fuel is essentially constituted by hydrogen and its magnecular clusters.

20. The chemical compositions of claim 18, wherein said combustible fuel is essentially constituted by oxygen and its magnecular clusters.

21. The chemical compositions of claim 18, wherein said combustible fuel is essentially constituted by oxygen and hydrogen bonded into magnecules.

22. The chemical compositions of claim 18, wherein carbon and its molecular composites have been essentially removed via chemical processes.

23. The chemical compositions of claim 18, wherein carbon and its molecular composites are removed from the combustion exhaust of said combustible fuel with magnecular structure.

24. The chemical compositions of claim 18, wherein said combustible fuel with magnecular structure is gasoline.

25. The chemical compositions of claim 18, wherein said combustible fuel with magnecular structure is diesel fuel.

26. The chemical compositions of claim 18, wherein said fuel with magnecular structure is a combination of one or more of conventional fuels.

27. The chemical compositions of claim 16, wherein said essentially pure population of magnecules is formed from molecules from at least two different liquids which are not soluble in each other.

28. The chemical compositions of claim 27, wherein the two liquids which are not soluble in each other are water and oil.

29. A chemical composition comprising:
a substantially pure population of gas magnecules composed of clusters of one of a molecule, a dimer, an atom and combinations thereof in combination with one of another molecule, dimer or atom, and any combination thereof said magnecules being detectable via peaks in mass spectrometry;
said peaks in the mass spectrometry being unidentifiable as any known conventional molecule and said magnecules having no infrared signature for a gas or ultraviolet signature for a liquid or other signature for a solid other than a corresponding signature of conventional molecules or dimers constituting said magnecules;
said magnecules being formed by mutual attractions among opposite polarities of a magnetic polarization of orbits of at least some peripheral electrons of atomic constituents of said magnecules in conjunction with a polarization of intrinsic magnetic moments of nuclei and a polarization of intrinsic magnetic moments of electrons, when a pair of said polarization of intrinsic magnetic moments of electrons is not correlated into antiparallel valence bonds; and
said essentially pure population of magnecules being constituted by a gas formed by forcing a liquid through an electric arc.

30. The chemical compositions of claim 29, wherein the direction of the liquid flow is perpendicular to the electrodes.

31. The chemical compositions of claim 29, wherein the direction of the liquid flow is parallel to the electrodes.

32. The chemical compositions of claim 29, wherein said magnetic polarizations of said orbits of peripheral electrons and said intrinsic magnetic moments are formed by subjecting a substance to any one of an external magnetic field, external electromagnetic field, microwave, pressure, friction, and any combination thereof.

33. The chemical compositions of claim 29, wherein said infrared signatures for gases or ultraviolet signatures for liquids or other signatures for solids due to conventional molecules and dimers constituting the magnecules are altered because of the presence of peaks not existing in conventional signatures.

34. The chemical compositions of claim 33, wherein said peaks not existing in conventional signatures originate from attractive forces between opposite inter-atomic polarities of a magnetic polarization of the orbits of at least some of the peripheral non-valence electrons of the atoms constituting said conventional molecule or dimer in conjunction with the polarization of the intrinsic magnetic moments of nuclei and of electrons, when not correlated into valence bonds with antiparallel spins.

35. The chemical compositions of claim 29, wherein the average density is greater than that of the conventional molecules constituting said magnecules and any of their combination under the same conditions of volume, pressure and temperature.

36. The chemical compositions of claim 29, wherein an excess energy content is released from a thermochemical reaction of said essentially pure population of magnecules as compared to the energy released by thermochemical reaction of any conventional molecular constituent and any combinations thereof.

37. The chemical compositions of claim 36, wherein the excess energy content is due to a storage of energy in the structure of said magnecules, said conventional molecules and said dimers constituting the magnecules.

38. The chemical compositions of claim 29, wherein said peaks in the mass spectrometry change in time while keeping constant the average magnecular density.

39. The chemical compositions of claim 29, wherein said essentially pure population of magnecules has an excess adhesion to other substances when compared to the adhesion of any molecule constituting said magnecules and any combinations thereof.

40. The chemical compositions of claim 39, wherein said excess adhesion originates from a magnetic polarization via induction of the orbit and intrinsic magnetic moments of atoms constituting said other substances to provide a bond between said magnecules and said other substances among opposite of said magnetic polarizations.

41. The chemical compositions of claim 29, wherein said essentially pure population of magnecules has an excess penetration within other substances as compared to that of any conventional molecule constituting said magnecules or that of any of combinations thereof.

42. The chemical compositions of claim 41, wherein said excess penetration originates from a reduction of an average size of conventional molecules constituting said magnecules due to magnetic polarization of the orbits of at least one of the peripheral electrons of the atoms constituting said magnecule.

43. The chemical compositions of claim 32, wherein said essentially pure population of magnecules is formed from a substance having a single molecule.

44. The chemical compositions of claim 32, wherein said essentially pure population of magnecules is formed from a substance having at least two different molecules.

45. The chemical compositions of claim 29, wherein said essentially pure population of magnecules is a combustible fuel.

46. The chemical compositions of claim 45, wherein said combustible fuel is essentially constituted by hydrogen and its magnecular clusters.

47. The chemical compositions of claim 45, wherein said combustible fuel is essentially constituted by oxygen and its magnecular clusters.

48. The chemical compositions of claim 45, wherein said combustible fuel is essentially constituted by oxygen and hydrogen bonded into magnecules.

49. The chemical compositions of claim 45, wherein carbon and its molecular composites have been essentially removed via chemical processes.

50. The chemical compositions of claim 45, wherein carbon and its molecular composites are removed from the combustion exhaust of said combustible fuel with magnecular structure.

51. The chemical compositions of claim 45, wherein said fuel with magnecular structure is formed from a combination of one or more of conventional fuels.

52. A chemical composition comprising:
a substantially pure population of liquid magnecules composed of clusters of one of a molecule, a dimer, an atom and combinations thereof in combination with one of another molecule, dimer or atom, and any combination thereof said magnecules being detectable via peaks in mass spectrometry;
said peaks in the mass spectrometry being unidentifiable as any known conventional molecule and said magnecules having no infrared signature for a gas or ultraviolet signature for a liquid or other signature for a solid other than a corresponding signature of conventional molecules or dimers constituting said magnecules;
said magnecules being formed by mutual attractions among opposite polarities of a magnetic polarization of orbits of at least some peripheral electrons of atomic constituents of said magnecules in conjunction with a polarization of intrinsic magnetic moments of nuclei and a polarization of intrinsic magnetic moments of electrons, when a pair of said polarization of intrinsic magnetic moments of electrons is not correlated into antiparallel valence bonds; and
said essentially pure population of magnecules being formed by forcing a liquid through an electric arc between at least one pair of electrodes.

53. The chemical compositions of claim 52, wherein the direction of the liquid flow is perpendicular to the electrodes.

54. The chemical compositions of claim 52, wherein the direction of the liquid flow is parallel to the electrodes.

55. The chemical compositions of claim 52, wherein said magnetic polarizations of said orbits of peripheral electrons and said intrinsic magnetic moments are formed by subjecting a substance to any one of an external magnetic field, external electromagnetic field, microwave, pressure, friction, and any combination thereof.

56. The chemical compositions of claim 52, wherein said infrared signatures for gases or ultraviolet signatures for liquids or other signatures for solids due to conventional molecules and dimers constituting the magnecules are altered because of the presence of peaks not existing in conventional signatures.

57. The chemical compositions of claim 56, wherein said peaks not existing in conventional signatures originate from attractive forces between opposite inter-atomic polarities of a magnetic polarization of the orbits of at least some of the peripheral non-valence electrons of the atoms constituting said conventional molecule or dimer in conjunction with the polarization of the intrinsic magnetic moments of nuclei and of electrons, when not correlated into valence bonds with antiparallel spins.

58. The chemical compositions of claim 52, wherein the average density is greater than that of the conventional molecules constituting said magnecules and any of their combination under the same conditions of volume, pressure and temperature.

59. The chemical compositions of claim 52, wherein an excess energy content is released from a thermochemical reaction of said essentially pure population of magnecules as compared to the energy released by thermochemical reaction of any conventional molecular constituent and any combinations thereof.

60. The chemical compositions of claim 59, wherein the excess energy content is due to a storage of energy in the structure of said magnecules, said conventional molecules and said dimers constituting the magnecules.

61. The chemical compositions of claim 52, wherein said peaks in the mass spectrometry change in time while keeping constant the average magnecular density.

62. The chemical compositions of claim 52, wherein said essentially pure population of magnecules has an excess adhesion to other substances when compared to the adhesion of any molecule constituting said magnecules and any combinations thereof.

63. The chemical compositions of claim 62, wherein said excess adhesion originates from a magnetic polarization via induction of the orbit and intrinsic magnetic moments of atoms constituting said other substances to provide a bond between said magnecules and said other substances among opposite of said magnetic polarizations.

64. The chemical compositions of claim 52, wherein said essentially pure population of magnecules has an excess penetration within other substances as compared to that of any conventional molecule constituting said magnecules or that of any of combinations thereof.

65. The chemical compositions of claim 64, wherein said excess penetration originates from a reduction of an average size of conventional molecules constituting said magnecules due to magnetic polarization of the orbits of at least one of the peripheral electrons of the atoms constituting said magnecule.

66. The chemical compositions of claim 55, wherein said essentially pure population of magnecules is formed from a substance having a single molecule.

67. The chemical compositions of claim 55, wherein said essentially pure population of magnecules is formed from a substance having at least two different molecules.

68. The chemical compositions of claim 52, wherein said essentially pure population of magnecules is a combustible fuel.

69. The chemical compositions of claim 68, wherein said combustible fuel is essentially constituted by liquid hydrogen and its magnecular clusters.

70. The chemical compositions of claim 68, wherein said combustible fuel is essentially constituted by liquid oxygen and its magnecular clusters.

71. The chemical compositions of claim 68, wherein said combustible fuel is essentially constituted by liquid oxygen and liquid hydrogen bonded into magnecules.

72. The chemical compositions of claim 68, wherein carbon and its molecular composites have been essentially removed via chemical processes.

73. The chemical compositions of claim 68, wherein carbon and its molecular composites are removed from the combustion exhaust of said combustible fuel with magnecular structure.

74. The chemical compositions of claim 68, wherein said combustible fuel with magnecular structure is gasoline.

75. The chemical compositions of claim 68, wherein said combustible fuel with magnecular structure is diesel fuel.

76. The chemical compositions of claim 68, wherein said fuel with magnecular structure is formed from a combination of one or more of conventional fuels.

77. The chemical compositions of claim 52, wherein said essentially pure population of magnecules is formed from molecules from at least two different liquids which are not soluble in each other.

78. The chemical compositions of claim 77, wherein the two liquids which are not soluble in each other are water and oil.

79. A chemical composition comprising:
a substantially pure population of gas magnecules composed of clusters of one of a molecule, a dimer, an atom and combinations thereof in combination with one of another molecule, dimer or atom, and any combination thereof said magnecules being detectable via peaks in mass spectrometry;
said peaks in the mass spectrometry being unidentifiable as any known conventional molecule and said magnecules having no infrared signature for a gas other than a corresponding signature of conventional molecules or dimers constituting said magnecules;
said magnecules being formed by mutual attractions among opposite polarities of a magnetic polarization of orbits of at least some peripheral electrons of atomic constituents of said magnecules in conjunction with a polarization of intrinsic magnetic moments of nuclei and a polarization of intrinsic magnetic moments of electrons, when a pair of said polarization of intrinsic magnetic moments of electrons is not correlated into antiparallel valence bonds; and
said essentially pure population of magnecules being formed by forcing a gas through an electric arc between at least one pair of electrodes.

80. The chemical compositions of claim 79, wherein the direction of the gas flow is perpendicular to the electrodes.

81. The chemical compositions of claim 79, wherein the direction of the gas flow is parallel to the electrodes.

82. The chemical compositions of claim 79, wherein said magnetic polarizations of said orbits of peripheral electrons and said intrinsic magnetic moments are formed by subjecting a substance to any one of an external magnetic field, external electromagnetic field, microwave, pressure, friction, and any combination thereof.

83. The chemical compositions of claim 79, wherein said infrared signatures for gases or ultraviolet signatures for liquids or other signatures for solids due to conventional molecules and dimers constituting the magnecules are altered because of the presence of peaks not existing in conventional signatures.

84. The chemical compositions of claim 83, wherein said peaks not existing in conventional signatures originate from attractive forces between opposite inter-atomic polarities of a magnetic polarization of the orbits of at least some of the peripheral non-valence electrons of the atoms constituting said conventional molecule or dimer in conjunction with the polarization of the intrinsic magnetic moments of nuclei and of electrons, when not correlated into valence bonds with antiparallel spins.

85. The chemical compositions of claim 79, wherein the average density is greater than that of the conventional molecules constituting said magnecules and any of their combination under the same conditions of volume pressure and temperature.

86. The chemical compositions of claim 79, wherein an excess energy content is released from a thermochemical reaction of said essentially pure population of magnecules as compared to the energy released by thermochemical reaction of any conventional molecular constituent and any combinations thereof.

87. The chemical compositions of claim 86, wherein the excess energy content is due to a storage of energy in the structure of said magnecules, said conventional molecules and said dimers constituting the magnecules.

88. The chemical compositions of claim 79, wherein said peaks in the mass spectrometry change in time while keeping constant the average magnecular density.

89. The chemical compositions of claim 79, wherein said essentially pure population of magnecules has an excess adhesion to other substances when compared to the adhesion of any molecule constituting said magnecules and any combinations thereof.

90. The chemical compositions of claim 89, wherein said excess adhesion originates from a magnetic polarization via induction of the orbit and intrinsic magnetic moments of atoms constituting said other substances to provide a bond between said magnecules and said other substances among opposite of said magnetic polarizations.

91. The chemical compositions of claim 79, wherein said essentially pure population of magnecules has an excess penetration within other substances as compared to that of any conventional molecule constituting said magnecules or that of any of combinations thereof.

92. The chemical compositions of claim 91, wherein said excess penetration originates from a reduction of an average size of conventional molecules constituting said magnecules due to magnetic polarization of the orbits of at least one of the peripheral electrons of the atoms constituting said magnecule.

93. The chemical compositions of claim 82, wherein said essentially pure population of magnecules is formed from a substance having a single molecule.

94. The chemical compositions of claim 82, wherein said essentially pure population of magnecules is formed from a substance having at least two different molecules.

95. The chemical compositions of claim 79, wherein said essentially pure population of magnecules is a combustible gas.

96. The chemical compositions of claim 95, wherein said combustible gas is essentially constituted by hydrogen and its magnecular clusters.

97. The chemical compositions of claim 95, wherein said combustible gas is essentially constituted by oxygen and its magnecular clusters.

98. The chemical compositions of claim 95, wherein said combustible gas is essentially constituted by oxygen and hydrogen bonded into magnecules.

99. The chemical compositions of claim 95, wherein carbon and its molecular composites have been essentially removed via chemical processes.

100. The chemical compositions of claim 95, wherein carbon and its molecular composites are removed from the combustion exhaust of said combustible gas with magnecular structure.

101. The chemical compositions of claim 95, wherein said gas with magnecular structure is formed from a combination of one or more of conventional gasses.
